(19) United States
(12) Patent Application Publication
(10) Pub. No.: US 2024/0371382 A1
(43) Pub. Date: Nov. 7, 2024

(54) Apparatus and method for harmonicity-dependent tilt control of scale parameters in an audio encoder

(71) Applicant: Fraunhofer-Gesellschaft zur Förderung der angewandten Forschung e.V., München (DE)

(72) Inventors: Goran MARKOVIC, Erlangen (DE); Bernd EDLER, Erlangen (DE)

(21) Appl. No.: 18/307,535

(22) Filed: Apr. 26, 2023

(51) Int. Cl. G10L 19/02; G10L 19/035; G10L 19/09; G10L 25/18

(52) U.S. Cl. CPC G10L 19/0204; G10L 19/035; G10L 19/09; G10L 25/18

(57) ABSTRACT

A method and an apparatus for encoding an audio signal. The apparatus includes a converter converting the audio signal into a spectral representation; a scale parameter calculator calculating scale parameters; a spectral processor processing the spectral representation using the scale parameters; and a scale parameter encoder generating an encoded representation of the scale parameters. The scale parameter calculator is calculates an amplitude-related measure for each band to obtain a set of amplitude-related measures. A pre-emphasis operation is performed to the amplitude-related measures, so that low frequency amplitudes are emphasized with respect to high frequency amplitudes according to a tilt value, or a pre-emphasis factor. The scale parameter calculator controls the tilt value, or the pre-emphasis factor, based on a harmonicity measure of the audio signal.

The present invention is related to audio processing and, particularly, to audio processing operating in a spectral domain using scale parameters for spectral bands. In examples, the invention refers to an apparatus and method for harmonicity-dependent tilt control of scale parameters in an audio encoder. E.g. the invention refers to an encoder or a method for encoding.

### PRIOR ART 1: ADVANCED AUDIO CODING (AAC)

In one of the most widely used state-of-the-art perceptual audio codec, Advanced Audio Coding (AAC) [1-2], spectral noise shaping is performed with the help of so-called scale factors.

In this approach, the MDCT spectrum is partitioned into a number of non-uniform scale factor bands. For example at 48 kHz, the MDCT has 1024 coefficients and it is partitioned into 49 scale factor bands. In each band, a scale factor is used to scale the MDCT coefficients of that band. A scalar quantizer with constant step size is then employed to quantize the scaled MDCT coefficients. At the decoder-side, inverse scaling is performed in each band, shaping the quantization noise introduced by the scalar quantizer.

The 49 scale factors are encoded into the bitstream as side-information. It usually requires a significantly high amount of bits for encoding the scale factors, due to the relatively high number of scale factors and the required high precision. This can become a problem at low bitrate and/or at low delay.

### PRIOR ART 2: MDCT-BASED TCX

In MDCT-based TCX, a transform-based audio codec used in the MPEG-D USAC [3] and 3GPP EVS [4] standards, spectral noise shaping is performed with the help of a LPC-based perceptual filer, the same perceptual filter as used in recent ACELP-based speech codecs (e.g. AMR-WB).

In this approach, a set of 16 LPCs is first estimated on a pre-emphasized input signal. The LPCs are then weighted and quantized. The frequency response of the weighted and quantized LPCs is then computed in 64 uniformly spaced bands. The MDCT coefficients are then scaled in each band using the computed frequency response. The scaled MDCT coefficients are then quantized using a scalar quantizer with a step size controlled by a global gain. At the decoder, inverse scaling is performed in every 64 bands, shaping the quantization noise introduced by the scalar quantizer.

This approach has a clear advantage over the AAC approach: it requires the encoding of only 16 (LPC)+1 (global-gain) parameters as side-information (as opposed to the 49 parameters in AAC). Moreover, 16 LPCs can be efficiently encoded with a small number of bits by employing a LSF representation and a vector quantizer. Consequently, the approach of prior art 2 requires less side-information bits as the approach of prior art 1, which can makes a significant difference at low bitrate and/or low delay.

However, this approach has also some drawbacks. The first drawback is that the frequency scale of the noise shaping is restricted to be linear (i.e. using uniformly spaced bands) because the LPCs are estimated in the time-domain. This is disadvantageous because the human ear is more sensible in low frequencies than in the high frequencies. The second drawback is the high complexity required by this approach. The LPC estimation (autocorrelation, Levinson-Durbin), LPC quantization (LPC<->LSF conversion, vector quantization) and LPC frequency response computation are all costly operations. The third drawback is that this approach is not very flexible because the LPC-based perceptual filter cannot be easily modified and this prevents some specific tunings that would be required for critical audio items.

### PRIOR ART 3: IMPROVED MDCT-BASED TCX

Some recent work has addressed the first drawback and partly the second drawback of prior art 2. It was published in U.S. Pat. No. 9,595,262 B2, EP2676266 B1. In this new approach, the autocorrelation (for estimating the LPCs) is no more performed in the time-domain but it is instead computed in the MDCT domain using an inverse transform of the MDCT coefficient energies. This allows using a non-uniform frequency scale by simply grouping the MDCT coefficients into 64 non-uniform bands and computing the energy of each band. It also reduces the complexity required to compute the autocorrelation.

### PRIOR ART 4: WO2019091573

WO2019091573 discloses an encoding apparatus in which scale parameters, used for spectral noise shaping, require small side information and has small computation complexity. See also the standards [5] and [6]. The scale factors are obtained from the band energies, where the band energies are obtained from the MDCT coefficients and normalized using band widths. In one aspect of WO2019091573, the pre-emphasis with fixed tilt is applied on the band energies to reduce quantization noise in low-frequencies. Different tilt is optimal for different types of signals and the fixed tilt of the pre-emphasis is not well suited for all types of signals, requiring a compromise in choosing it and this is not addressed in WO2019091573, [5], [6]. E.g. optimal pre-emphasis tilt is different for harmonic and for transient like signals. Further the MDCT spectra has temporal variation for constant amplitude signals which leads to temporal variation of SNS scale factors even for constant amplitude signals and this is also not addressed in WO2019091573, [5], [6]. This variation leads to temporally varying quantization of constant amplitude signals and thus to quality degradation. The normalization of the band energies with the band widths, as used in WO2019091573,[5],[6], can be avoided, by adapting the pre-emphasis tilt and thus achieving computational complexity reduction.

WO2019091573 discloses an encoding apparatus in which downsampling of scale parameters is carried out. See also the standards [5] and [6]. However, there is no control of pre-emphasis tilt based on harmonicity.

### ASPECTS

According to an aspect, there is provided an Apparatus for encoding an audio signal, comprising:
a converter for converting the audio signal into a spectral representation;
a scale parameter calculator for calculating a set of scale parameters based on the audio signal;
a spectral processor for processing the spectral representation, or at least part thereof, using the set of scale parameters, or a modified version thereof;
a scale parameter encoder for generating an encoded representation of the scale parameters, or of the modified version of the scale parameters, wherein the scale parameter calculator is configured to calculate an amplitude-related measure for each band to obtain a set of amplitude-related measures, the scale parameter calculator being configured to perform a pre-emphasis operation to the set of amplitude-related measures, so that low frequency amplitudes are emphasized with respect to high frequency amplitudes according to a tilt value, or a pre-emphasis factor, wherein the scale parameter calculator is configured to control the tilt value, or the pre-emphasis factor, based on a harmonicity measure of the audio signal, to thereby obtain the set of scale parameters; and
an output interface to generate an encoded audio signal comprising information on an encoded representation of the spectral representation, or the at least part thereof, and information on the encoded representation of the scale parameters or of the modified version of the scale parameters.

The apparatus may be configured to obtain the harmonicity measure of the audio signal as an autocorrelation of the audio signal.

The apparatus may be configured to obtain the harmonicity measure of the audio signal using a normalized autocorrelation measurement of the audio signal.

The apparatus may be such that the harmonicity measure of the audio signal is a value between 0 and a value different from zero, so that a lower harmonicity is closer to 0 than a higher harmonicity.

The scale parameter calculator may be configured so that a comparatively higher value of the harmonicity measure of the audio signal causes a higher tilt value, or a higher pre-emphasis factor, than a comparatively lower value of the harmonicity measure.

The apparatus may be such that the scale parameter calculator is configured to process the amplitude-related measures to verify

$${E}_{p} ( b ) = {E}_{s} ( b ) \cdot {d}^{( \frac{b \cdot {g}_{tilt} \cdot {g}^{′}}{h \cdot nb} )} ,$$

$$where \frac{b \cdot {g}_{tilt} \cdot {g}^{′}}{h \cdot nb}$$

is the tilt value, which is an exponent applied to d, where h is fixed, g′≥0 is, or is derived from, the harmonicity measure, gₜᵢₗₜ is pre-defined, b is an index indicating the band out of nb+1 bands in such a way that a higher frequency band has a higher index than a lower frequency band, Eₛ(b) is the set of amplitude-related measures and Eₚ(b) is a pre-emphasized energy per band.

The apparatus may be such that the scale parameter calculator is configured to process the amplitude-related measures by applying the tilt value to be proportional with at least the harmonicity measure, or the pre-emphasis factor to be obtained by raising a constant number with an exponent proportional with at least the harmonicity measure.

The apparatus may be such that the scale parameter calculator is configured to process the amplitude-related measures by applying the tilt value to be proportional with at least an index which increases with higher bands, or the pre-emphasis factor obtained by raising a constant number with an exponent proportional with at least an index which increases with higher bands.

The apparatus may be such that the scale parameter calculator is configured to process the amplitude-related measures by applying the tilt value, or the pre-emphasis factor, to be dependent on the bandwidth of the spectral representation.

The apparatus may be such that the scale parameter calculator is configured to process the amplitude-related measures by applying the tilt value to be linear with the harmonicity measure, or pre-emphasis factor to be obtained by raising a constant number with an exponent which is linear with the harmonicity measure.

The apparatus may be such that the scale parameter calculator is configured to obtain the amplitude-related measures from a squared magnitude spectrum of the audio signal.

The apparatus may be such that each amplitude-related measure is obtained as an integral, or a sum, of squared magnitude values of the spectrum of the audio signal.

The apparatus may be such that the integral, or sum, of the squared magnitude values of the spectrum of the audio signal is not normalized using the width of each band.

The apparatus may be such that the integral, or sum, of the squared magnitude values of the spectrum of the audio signal is obtained, for each index, by a sum of a squared modified discrete cosine transform, MDCT, coefficient and a squared modified discrete cosine transform, MDST, coefficient.

The apparatus may be such that the converter is configured to perform an MDCT transformation and an MDST transformation, to provide MDCT coefficients and MDST coefficients, wherein the amplitude-related measure for each band is obtained as sum of magnitudes of the MDCT coefficients, or a squared version(s) thereof, and magnitudes of the MDST coefficients, or a squared version(s) thereof.

The apparatus may be such that the scale parameter calculator is configured to control the tilt value or the pre-emphasis factor based on a long term predictor, LTP, parameter or on a long term post-filter LTPF parameter as the harmonicity measure of the audio signal.

The apparatus may be such that the scale parameter calculator is configured to control the tilt value or the pre-emphasis factor based on a spectral flatness measure as the harmonicity measure of the audio signal.

The apparatus may be configured to quantize the harmonicity measure of the audio signal, so as to control the tilt value or the pre-emphasis factor based on quantized version of the harmonicity measure of the audio signal.

The apparatus may further comprise a downsampler to downsample the set of scale parameters, which is a first set of scale parameters, to obtain a second set of scale parameters, which is, or is comprised in, the modified version of the first set of scale parameters, the second set of scale parameters having a second number of scale parameters which is lower than a first number of scale parameters of the first set of scale parameters, wherein the scale parameter encoder is configured to generate the encoded representation of the second set of scale parameters as the encoded representation of the modified version of the scale parameters.

The apparatus may further comprise a downsampler to downsample the set of scale parameters, which is a first set of scale parameters, to obtain a second set of scale parameters, the second set of scale parameters having a second number of scale parameters which is lower than a first number of scale parameters of the first set of scale parameters,
wherein the spectral processor is configured to process the spectral representation, or the at least part thereof, using a third set of scale parameters, which is, or is comprised in, the modified version of scale parameters, the second set of scale parameters having a second number of scale parameters which is lower than a third number of scale parameters of the second set of scale parameters.

The apparatus may be such that the spectral processor is configured to determine this third set of scale parameters so that the third number is equal to the first number.

The apparatus may be such that the scale parameter calculator is configured to
calculate, for each band of a plurality of bands of the spectral representation, the amplitude-related measures in a linear domain to obtain a first set of linear domain measures;
to transform the first set of linear-domain measures into a log-like domain to obtain the first set of log-like domain measures; and
wherein the downsampler is configured to downsample the first set of scale factors in the log-like domain to obtain the second set of scale factors in the log-like domain.

The apparatus may be such that the spectral processor is configured to use the first set of scale parameters in the linear domain for processing the spectral representation or to interpolate the second set of scale parameters in the log-like domain to obtain interpolated log-like domain scale factors and to transform the log-like domain scale factors into a linear domain to obtain the third set of scale parameters.

The apparatus may be such that the scale parameter calculator is configured to calculate the first set of scale parameters for non-uniform bands, and
wherein the downsampler is configured to downsample the first set of scale parameters to obtain a first scale factor of the second set by combining a first group having a first predefined number of frequency adjacent scale parameters of the first set, and wherein the downsampler is configured to downsample the first set of scale parameters to obtain a second scale parameter of the second set by combining a second group having a second predefined number of frequency adjacent scale parameters of the first set, wherein the second predefined number is equal to the first predefined number, and wherein the second group has members that are different from members of the first predefined group.

The apparatus may be such that the first group of frequency adjacent scale parameters of the first set and the second group of frequency adjacent scale parameters of the first set have at least one scale parameter of the first set in common, so that the first group and the second group overlap with each other.

The apparatus may be such that the downsampler is configured to use an average operation among a group of first scale parameters, the group having two or more members.

The apparatus may be such that the average operation is a weighted average operation configured to weight a scale parameter in a middle of the group stronger than a scale parameter at an edge of the group.

The apparatus may be such that the downsampler is configured to perform a mean value removal so that the second set of scale parameters is mean free.

The apparatus may be such that the downsampler is configured to perform a scaling operation using a scaling factor lower than 1.0 and greater than 0.0 in a log-like domain.

The apparatus may be configured to provide a second set of quantized scale factors associated with the encoded representation, and
wherein the spectral processor is configured to derive the second set of scale factors from the second set of quantized scale factors.

The apparatus may be configured to quantize and encode the second set using a vector quantizer, wherein the encoded representation comprises one or more indices for one or more vector quantizer codebooks.

The apparatus may be such that the spectral processor is configured to determine an interpolated scale factor based on a quantized scale factor and a difference between the quantized scale factor and a next quantized scale factor in an ascending sequence of quantized scale factors with respect to frequency.

The apparatus may be such that the spectral processor is configured to determine, from the quantized scale factor and the difference, at least two interpolated scale factors, wherein for each of the two interpolated scale factors, a different weighting factor is used.

The apparatus may be such that the weighting factors increase with increasing frequencies associated with the interpolated scale factors.

The apparatus may be such that the spectral processor is configured to perform an interpolation operation in a log-like domain, and
to convert interpolated scale factors into a linear domain to obtain the third set of scale parameters.

The apparatus may be such that the scale parameter calculator is configured to calculate an amplitude-related measure for each band to obtain a set of amplitude-related measures, and
to smooth, the energy-related measures to obtain a set of smoothed amplitude-related measures as the set of scale factors.

The apparatus may be such that the scale parameter calculator is configured to calculate an amplitude-related measure for each band to obtain a set of amplitude-related measures, and
to perform a pre-emphasis operation to the set of amplitude-related measures, wherein the pre-emphasis operation is so that low frequency amplitudes are emphasized with respect to high frequency amplitudes.

The apparatus may be such that the scale parameter calculator is configured to calculate an amplitude-related measure for each band to obtain the set of amplitude-related measures, and to perform a noise-floor addition operation, wherein a noise floor is calculated from an amplitude-related measure derived as a mean value from two or more frequency bands of the spectral representation.

The apparatus may be such that the scale factor calculator is configured to perform at least one of a group of operations, the group of operations comprising performing a smoothing operation, performing a pre-emphasis operation, performing a noise-floor addition operation, and performing a log-like domain conversion operation to obtain the first set of scale parameters.

The apparatus may be such that the spectral processor is configured to scale spectral values in the spectral representation using the set of scale factors, or modified version thereof, to obtain a scaled spectral representation and to apply a temporal noise shaping (TNS) operation onto the scaled spectral representation, and
wherein the spectral processor is configured to quantize and encode a result of the temporal noise shaping operation to obtain the encoded representation of the spectral representation.

The apparatus may be such that the converter uses an analysis window to generate a sequence of blocks of windowed audio samples, and a time-spectrum converter for converting the blocks of windowed audio samples into a sequence of spectral representations, a spectral representation being a spectral frame or a spectrum of the audio signal.

The apparatus may be such that the converter is configured to apply a modified discrete cosine transform, MDCT, operation to obtain an MDCT spectrum from a block of time domain samples, or
wherein the scale factor calculator is configured to calculate, for each band, an energy of the band, the calculation comprising squaring spectral lines, adding squared spectral lines, or
wherein the spectral processor is configured to scale spectral values of the spectral representation or to scale spectral values derived from the spectral representation in accordance with a band scheme, the band scheme being identical or different to the band scheme used in calculating the set of scale factors by the scale factor calculator, or
wherein a number of bands is 64, a first number is 64, a second number is 16, and a third number is 64, or
wherein the spectral processor is configured to calculate a global gain for all bands and to quantize the spectral values subsequent to a scaling involving the third number of scale factors using a scalar quantizer, wherein the spectral processor is configured to control a step size of the scalar quantizer dependent on the global gain.

In accordance to an aspect, the scale parameter calculator may obtain the set of amplitude-related measures as a set of energies per bands.

In accordance to an aspect, the converter may perform a first conversion to obtain a first part of the spectral representation and a second conversion to obtain a second part of the spectral representation, or wherein the converter is configured to perform a single conversion to obtain the spectral representation that has a first part of the spectral representation and a second part of the spectral representation, wherein the first part of the spectral representation is provided to the spectral processor, and the second part of the spectral representation is not processed by the spectral processor, and both the first part of the spectral representation and the second part of the spectral representation are provided to the scale parameter calculator to calculate the set of scale parameters based on both the first part of the spectral representation and the second part of the spectral representation.

In accordance to an aspect, the first part of the spectral representation is formed by MDCT coefficients and the second part of the spectral representation is formed by MDST coefficients, or the first part of the spectral representation is formed by MDST coefficients and the second part of the spectral representation is formed by MDCT coefficients.

In accordance to an aspect, the scale parameter calculator may be configured to obtain the amplitude-related measures from the first part of the spectral representation, squared, summed to the second part of the spectral representation, squared.

In accordance to an aspect, the scale parameter calculator is configured to obtain the amplitude-related measures from the spectral representation, or at least part thereof.

In accordance to an aspect, there is provided a method for encoding an audio signal, comprising:
converting the audio signal into a spectral representation;
calculating a set of scale parameters based on the audio signal;
processing the spectral representation, or at least part thereof, using the set of scale parameters, or a modified version thereof;
generating an encoded representation of the scale parameters, or of the modified version of the scale parameters;
wherein calculating includes calculating an amplitude-related measure for each band to obtain a set of amplitude-related measures, wherein calculating comprises performing a pre-emphasis operation to the set of amplitude-related measures, so that low frequency amplitudes are emphasized with respect to high frequency amplitudes according to a tilt value, or according to a pre-emphasis factor, wherein calculating comprises controlling the tilt value or controlling the pre-emphasis factor based on a harmonicity measure of the audio signal, to thereby obtain the set of scale parameters;
generating an encoded audio signal comprising information on an encoded representation of the spectral representation, or the at least part thereof, and information on the encoded representation of the scale parameters or of the modified version of the scale parameters.

In accordance to an aspect, there is provided a non-transitory storage unit storing instruction which, when executed by a processor, cause the processor to control or perform the method above.

### DRAWINGS

Preferred embodiments of the present invention are subsequently described in more detail with respect to the accompanying drawings, in which:

FIG. 1a is a block diagram of an apparatus for encoding an audio signal.

FIG. 1b is another block diagram of an apparatus for encoding an audio signal

FIG. 1c is a variant of FIG. 1a.

FIG. 1d is a variant of FIG. 1b.

FIG. 1e is a variant of FIG. 1a.

FIG. 1f is a variant of FIG. 1b.

FIG. 2 is a schematic representation of a preferred implementation of the scale factor calculator of FIG. 1;

FIG. 3 is a schematic representation of a preferred implementation of the downsampler of FIG. 1;

FIG. 4 is a schematic representation of the scale factor encoder of FIG. 4;

FIG. 5 is a schematic illustration of the spectral processor of FIG. 1;

FIG. 6 illustrates a general representation of an encoder on the one hand and a decoder on the other hand implementing spectral noise shaping (SNS);

FIG. 7 illustrates a more detailed representation of the encoder-side on the one hand and the decoder-side on the other hand where temporal noise shaping (TNS) is implemented together with spectral noise shaping (SNS);

FIG. 8 illustrates a block diagram of an apparatus for decoding an encoded audio signal;

FIG. 9 illustrates a schematic illustration illustrating details of the scale factor decoder, the spectral processor and the spectrum decoder of FIG. 8;

FIG. 10 illustrates a subdivision of the spectrum into 64 bands;

FIG. 11 illustrates a schematic illustration of the downsampling operation on the one hand and the interpolation operation on the other hand;

FIG. 12a illustrates a time-domain audio signal with overlapping frames;

FIG. 12b illustrates an implementation of the converter of FIG. 1; and

FIG. 12c illustrates a schematic illustration of the converter of FIG. 8.

FIG. 13 is a block diagram of an apparatus for encoding an audio signal.

FIG. 14 shows a technique for performing pre-emphasis.

FIG. 15 shows an example of frequency band division of an audio signal.

FIG. 16 shows an example of decoder.

FIG. 17 shows a technique for locating pitch contour parameters.

It is anticipated that, with the present invention, a pre-emphasis is performed to be dependent on the harmonicity of the audio signal.

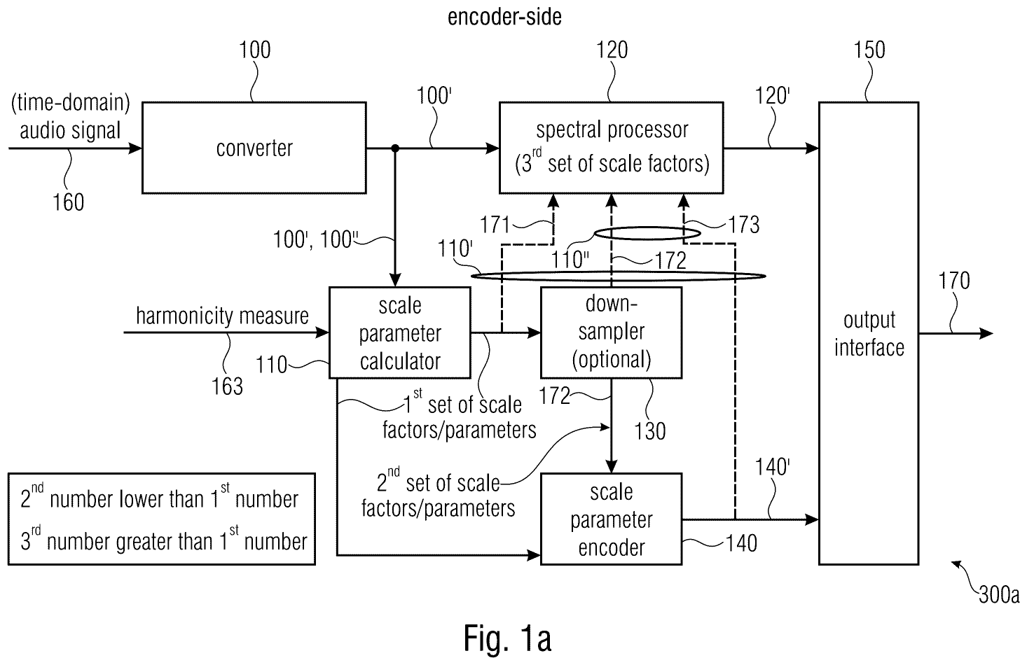

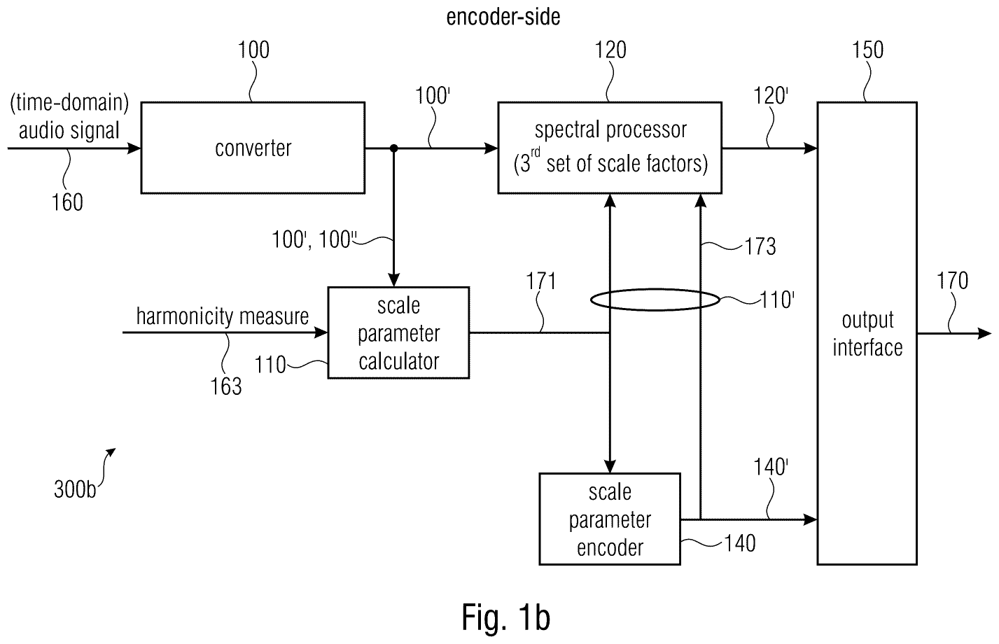

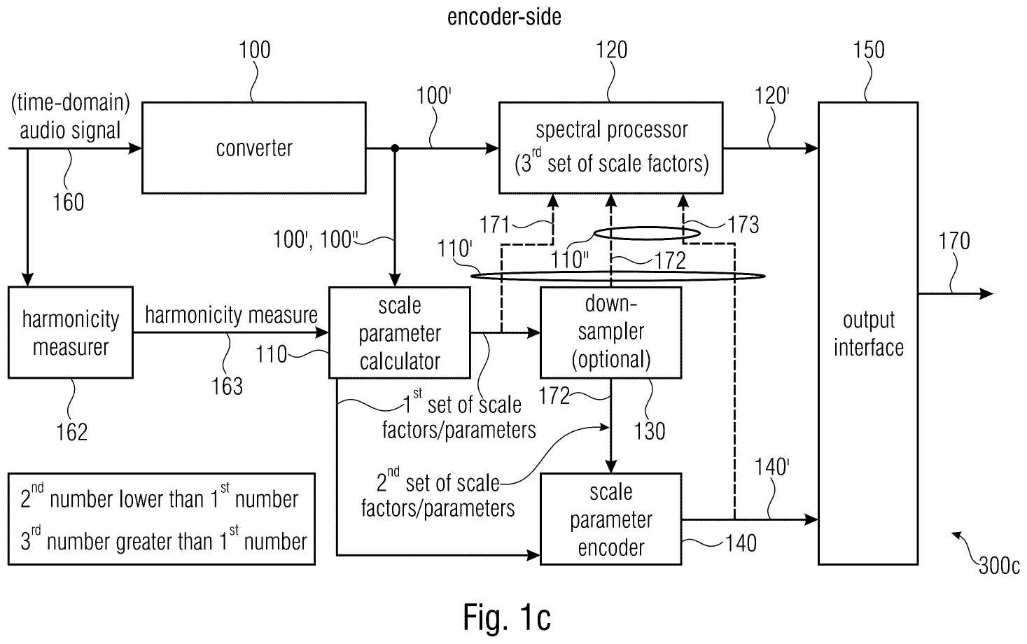

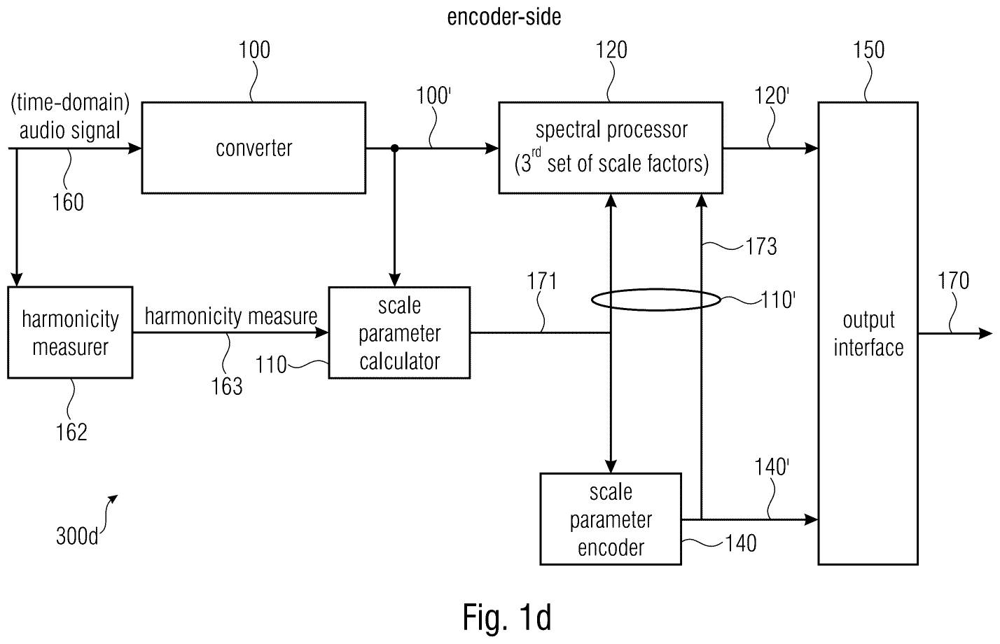

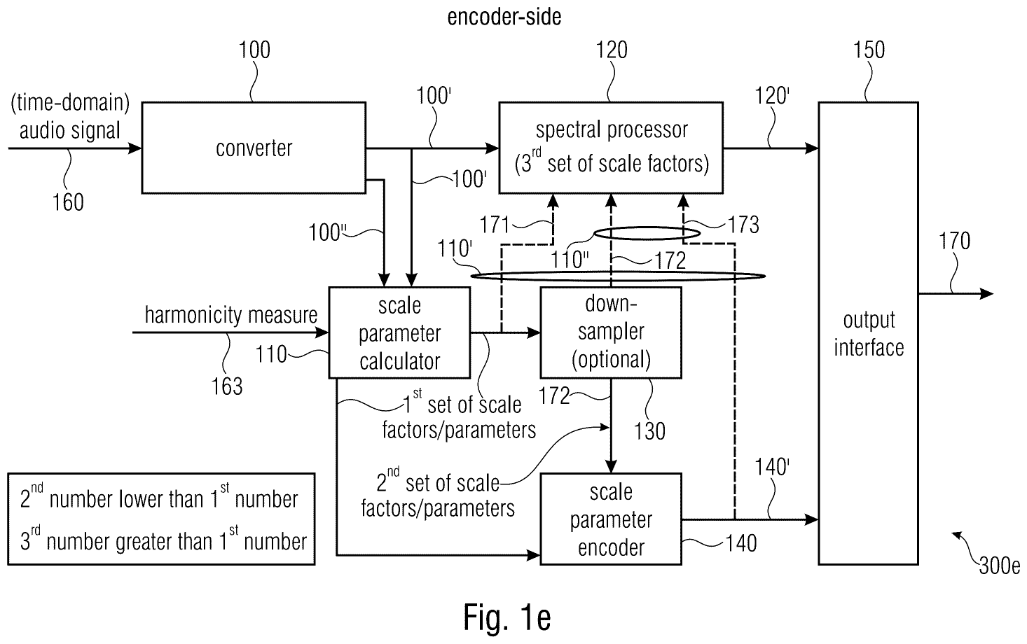

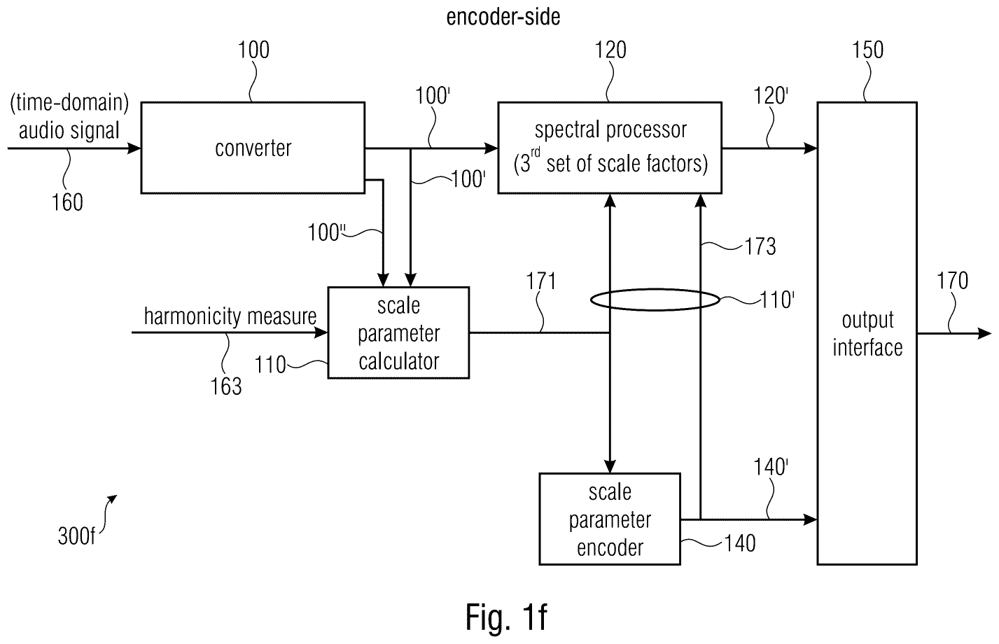

FIGS. 1a to 1e show, respectively, two examples of apparatus (300a, 300b, 300c, 300d, 300e, 300f) for encoding an audio signal (160), comprising:
a converter (100) for converting the audio signal (160) into a spectral representation (100′);
a scale parameter calculator (110) for calculating a set of scale parameters (171) based on the audio signal (160);
a spectral processor (120) for processing the spectral representation (100′) using the set of scale parameters (171), or a modified version (110″ in FIG. 1a, such as 172, 173) of the set of scale parameters (e.g. 171 in FIG. 1a);
a scale parameter encoder (140) for generating an encoded representation (140′) of the scale parameters, or of the modified version of the scale parameters (171);
wherein the scale parameter calculator (110) is configured to calculate an amplitude-related measure (e.g. energy per band) for each band to obtain a set of amplitude-related measures, the scale parameter calculator (110) being configured to perform (113) a pre-emphasis operation to the set of amplitude-related measures, so that low frequency amplitudes are emphasized with respect to high frequency amplitudes according to a tilt value, or according to a pre-emphasis factor,
wherein the scale parameter calculator (110) is configured to control the tilt value, or the pre-emphasis factor, based on a harmonicity measure (163) of the audio signal (160), to thereby obtain the set of scale parameters (171);
an output interface (150) to generate an encoded audio signal (170) comprising information on an encoded representation (120′) of the spectral representation (100′) and information on the encoded representation (e.g. 140′) of the scale parameters (171) or of the modified version of the scale parameters (100″, e.g. 172 or 173).

FIGS. 1a, 1b, 1c, 1d, 1e, if illustrate an apparatuses 300a, 300b, 300c, 300d, 300e, 300f (respectively) for encoding an audio signal 160. The audio signal 160 preferably is available in the time-domain, although other representations of the audio signal 160 such as a prediction-domain or any other domain would principally also be useful. The apparatus 300a or 300b may comprise a converter 100, a scale factor calculator 110, a spectral processor 120, an optional downsampler 130 (only in the variant 300a of FIG. 1a), a scale factor encoder 140 and an output interface 150. The converter 100 is configured for converting the audio signal 160 into a spectral representation 100′. The scale factor calculator 110 is configured for calculating a first set of scale parameters or scale factors (171) from the spectral representation 100′.

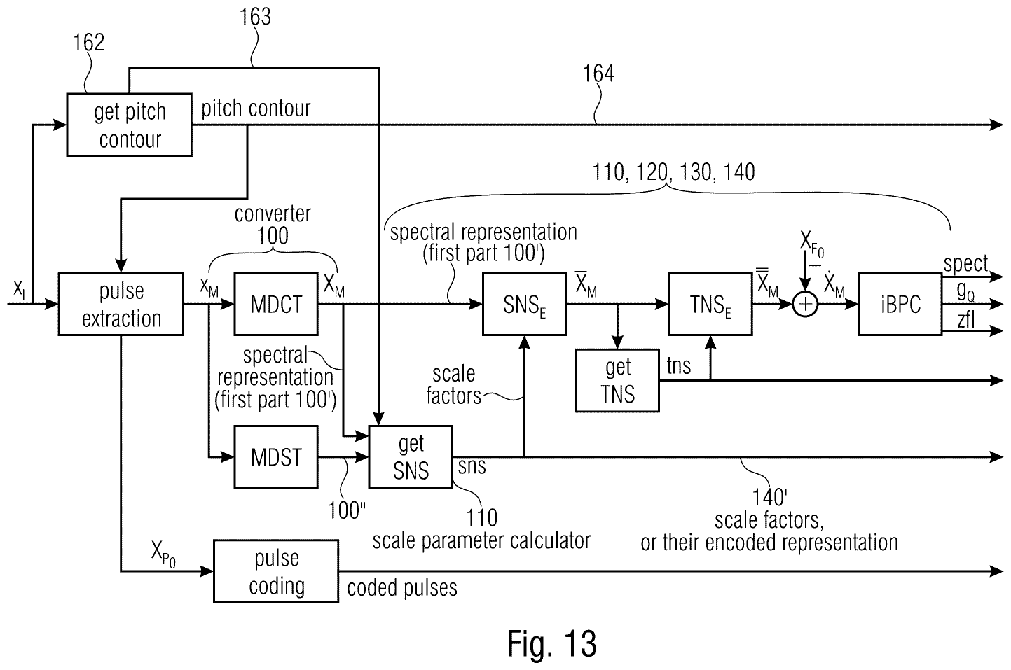

FIGS. 1c, 1d, 1e, if show variants 300c, 300d, 300e, 300f. The apparatus 300c of FIG. 1c is a variant of the apparatus 300a: there is only shown that the harmonicity measure 163 is obtained by a harmonicity measurer 162, which in turns acquires the harmonicity from the original version 160 (e.g. in the time domain) of the audio signal. This can be carried out also in FIG. 1a, which does not show the origin of the harmonicity measure 163 for the sake of simplicity. It is to be noted that, in some examples (e.g. in FIG. 1a but not in FIG. 1c) the harmonicity measure may be obtained, for example, from the spectral representation 100′, or a part of it. The apparatus 300d of FIG. 1d is a variant of the apparatus 300c, and, like in FIG. 1c, there is shown the harmonicity measurer 162 acquiring a harmonicity measure 163 from the time-domain version 160 of the audio signal. An example of harmonicity measurer 162 will be provided in FIG. 13, as get-pitch-contour block 162, which provides a harmonicity measure 163 besides providing a pitch contour 164.

FIGS. 1e and 1f are variants, respectively, of FIG. 1a (or 1c) and 1b (or 1d). FIGS. 1e and 1f show that the converter 100 converts the audio signal 160 into a spectral representation which has a first part 100′ (e.g., MDCT coefficients) and a second part 100″ (e.g. MDST coefficients): the first part 100′ may be submitted to the spectral processor 120, so that the spectral processor 120 provides the encoded representation (120′) of the spectral representation (100′) based on the first part 100′ but not on the second part 100″. However (as shown, for example, in FIG. 13), both the first part 100′ and second part 100″ of the spectral representation are provided to the scale parameter calculator 120, so that the set of scale parameters 171 (and/or the processed or downsampled version thereof, e.g. 172, 173, 140′) is obtained based on both the first part 100′ and second part 100″ of the spectral representation of the audio signal 160.

Throughout the specification, the term “scale factor” or “scale parameter” (171) is used in order to refer to the same parameter or value, i.e., a value or parameter that is, subsequent to some processing, used for weighting some kind of spectral values (mathematically, it will be expressed as g_{SNS}, for example). This weighting, when performed in the linear domain is actually a multiplying operation with a scaling factor. However, when the weighting is performed in a logarithmic domain, then the weighting operation with a scale factor is done by an actual addition or subtraction operation. Thus, in the terms of the present application, scaling does not only mean multiplying or dividing but also means, depending on the certain domain, addition or subtraction or, generally means each operation, by which the spectral value, for example, is weighted or modified using the scale factor or scale parameter.

The downsampler 130 (optional) of the apparatus 300a (or 300c or 300e) of FIG. 1a (or FIG. 1c or FIG. 1e) is configured for downsampling the first set of scale parameters 171 to obtain a second set of scale parameters (indicated with 110″, and which may be instantiated by either 172 or 173 according to the particular example), wherein a second number of the scale parameters in the second set of scale parameters 172 is lower than a first number of scale parameters in the first set of scale parameters 171. This is also outlined in the box in FIG. 1a (and FIG. 1c and FIG. 1e) stating that the second number is lower than the first number. As illustrated in FIG. 1a (and FIG. 1c and FIG. 1e), the scale factor encoder 140 is configured for generating an encoded representation 140′ of the second set of scale factors (172), and this encoded representation 140′ is forwarded to the output interface 150. Due to the fact that the second set of scale factors 172 has a lower number of scale factors than the first set of scale factors 171, the bitrate for transmitting or storing the encoded representation of the second set of scale factors is lower compared to a situation, in which the downsampling of the scale factors performed in the downsampler 130 would not have been performed. It is notwithstanding notable that the downsampler 130 may be skipped, and the scale factors may be provided to the spectral processor 120 directly through line 171.

Furthermore, the spectral processor 120 of the apparatus 300a (or 300c or 300e) of FIG. 1a (or FIG. 1c or FIG. 1e) may be optionally configured for processing the spectral representation 100′ output by the converter 100 in FIG. 1a (or FIG. 1c or FIG. 1e) using a third set of scale parameters 173, the third set of scale parameters or scale factors 173 having a third number of scale factors being greater than the second number of scale factors 172, wherein the spectral processor 120 may be optionally configured to use, for the purpose of spectral processing the first set of scale factors as already available from block 110 via line 171. Alternatively, the spectral processor 120 may be optionally configured to use the second set of scale factors 172 as output by the optional downsampler 130 for the calculation of the third set of scale factors as illustrated by line 172. In a further implementation, the spectral processor 120 optionally uses the encoded representation 140″ output by the scale factor/parameter encoder 140 for the purpose of calculating the third set of scale factors as illustrated by line 173 in FIGS. 1a-1f. Preferably, the spectral processor 120 does not use the first set of scale factors 171, but uses either the second set of scale factors 172 as calculated by the downsampler 130 or even more preferably uses the encoded representation 140″ or, generally, the quantized second set of scale factors and, then, performs an interpolation operation to interpolate the quantized second set of spectral parameters to obtain the third set of scale parameters that has a higher number of scale parameters due to the interpolation operation.

Thus, the encoded representation 140″ of the second set of scale factors 172 that is output by block 140 either comprises a codebook index for a preferably used scale parameter codebook or a set of corresponding codebook indices. In other embodiments, the encoded representation comprises the quantized scale parameters of quantized scale factors that are obtained, when the codebook index or the set of codebook indices or, generally, the encoded representation is input into a decoder-side vector decoder or any other decoder. Preferably, the spectral processor 120 uses the same set of scale factors that is also available at the decoder-side, i.e., uses the quantized second set of scale parameters together with an interpolation operation to finally obtain the third set of scale factors.

In a preferred, optional embodiment, the third number of scale factors in the third set of scale factors 173 is equal to the first number of scale factors. However, a smaller number of scale factors is also useful. Exemplarily, for example, one could derive 64 scale factors (171) in block 110, and the downsampler (130) could then downsample the 64 scale factors (171) to 16 scale factors (140′) for transmission. Then, there could be performed an interpolation not necessarily to 64 scale factors, but to 32 scale factors (e.g. third number of scale factors) in the spectral processor 120. Alternatively, one could perform an interpolation to an even higher number (e.g. third number, which may be equal to or greater than the first number) such as more than 64 scale factors as the case may be, as long as the number of scale factors transmitted in the encoded output signal (170) is smaller than the number of scale factors calculated in block 110 or calculated and used in block 120 of FIGS. 1a-1f.

In general terms, the scale factors may be either provided to the spectral processor 120 either in their native form (e.g. 171) or in a modified version (e.g., 172 or 173). In FIG. 1b there are shown 171 and 173. It is mostly referred to the fact that the scale factors are used either in their native form (171) or in a processed version (e.g. 172, 140″, complexively indicated with 110″); reference numeral 110′ is used for the general concept of the scale factors or a processed version thereof.

Summarizing, in the examples of FIGS. 1a-1f at least one of the arrows 171, 172, 173 directed towards the spectral processor 120 is needed and the others may be skipped.

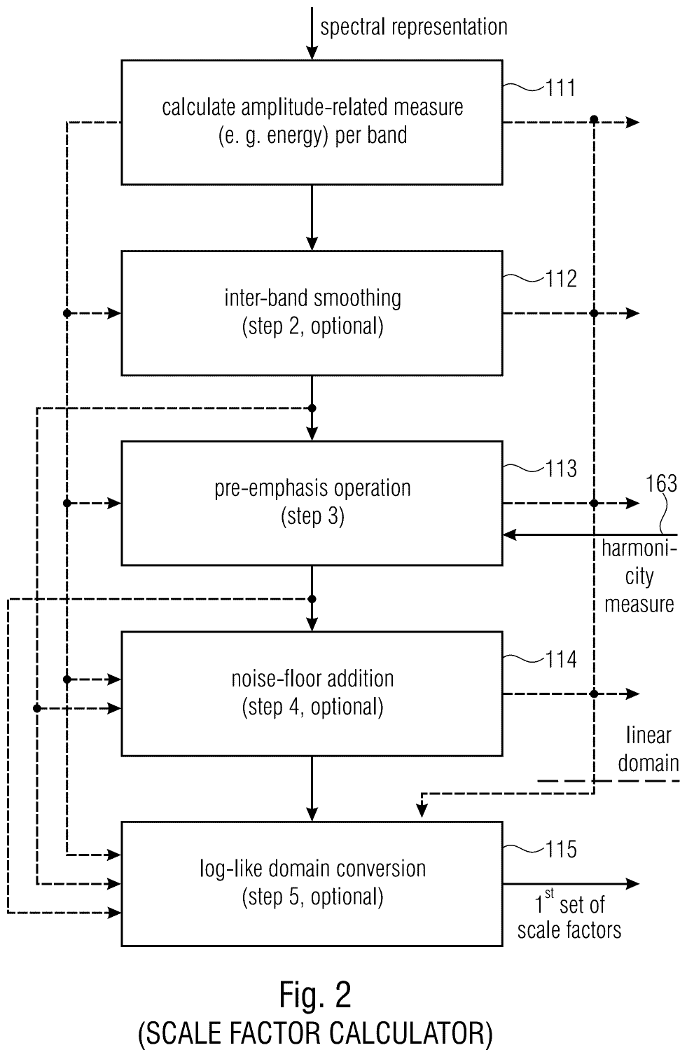

Preferably, the scale factor calculator 110 is configured to perform several operations illustrated in FIG. 2. These operations refer to a calculation 111 of an amplitude-related measure per band. A preferred amplitude-related measure per band is the energy per band, but other amplitude-related measures can be used as well, for example, the summation of the magnitudes of the amplitudes per band or the summation (integral, sum, etc.) of squared amplitudes which corresponds to the energy. However, apart from the power of 2 used for calculating the energy per band, other powers such as a power of 3 that would reflect the loudness of the signal could also be used and, even powers different from integer numbers such as powers of 1.5 or 2.5 can be used as well in order to calculate amplitude-related measures per band. Even powers less than 1.0 can be used as long as it is made sure that values processed by such powers are positive-valued.

A further operation performed by the scale factor calculator can be an optional inter-band smoothing 112. This inter-band smoothing is preferably used to smooth out the possible instabilities that can appear in the vector of amplitude-related measures as obtained by step 111. If one would not perform this smoothing, these instabilities would be amplified when converted to a log-domain later as illustrated at 115, especially in spectral values where the energy is close to 0. However, in other embodiments, inter-band smoothing is not performed.

An operation according to the invention, performed by the scale factor calculator 110, is the pre-emphasis operation 113. This pre-emphasis operation has a similar purpose as a pre-emphasis operation e.g. used in an LPC-based perceptual filter of the MDCT-based TCX processing as discussed before with respect to the prior art. This procedure increases the amplitude of the shaped spectrum in the low-frequencies that results in a reduced quantization noise in the low-frequencies.

The pre-emphasis operation 113 makes use of a harmonicity measure 163 as acquired. The scale parameter calculator 110 calculates an amplitude-related measure for each band (e.g. energy per band), to obtain a set of amplitude-related measures. The scale parameter calculator performs the pre-emphasis operation (113) to the set of amplitude-related measures, so that low frequency amplitudes are emphasized with respect to high frequency amplitudes according to a tilt value controlled by the tilt value, which in turn is based on a harmonicity measure (163) of the audio signal 160. According to a first option, the harmonicity measure 163 may be obtained (e.g. in the frequency domain), downstream to the converter 100, e.g. as spectral flatness measure, e.g. calculated from the spectral representation 100′. According to a second option, the harmonicity measure 163 may be obtained from the input audio signal 160 (e.g. in the time domain), upstream to the converter 100.

A further optional processing operation is the noise-floor addition processing 114. This procedure improves the quality of signals containing very high spectral dynamics such as, for example, Glockenspiel, by limiting the amplitude amplification of the shaped spectrum in the valleys, which has the indirect effect of reducing the quantization noise in the peaks, at the cost of an increase of quantization noise in the valleys, where the quantization noise is anyway not perceptible due to masking properties of the human ear such as the absolute listening threshold, the pre-masking, the post-masking or the general masking threshold indicating that, typically, a quite low volume tone relatively close in frequency to a high volume tone is not perceptible at all, i.e., is fully masked or is only roughly perceived by the human hearing mechanism, so that this spectral contribution can be quantized quite coarsely. The noise-floor addition operation 114, however, does not necessarily have to be performed.

Furthermore, block 115 indicates a log-like domain conversion. Preferably, a transformation of an output of one of blocks 111, 112, 113, 114 in FIG. 2 is performed in a log-like domain. A log-like domain is a domain, in which values close to 0 are expanded and high values are compressed. Preferably, the log domain is a domain with basis of 2, but other log domains can be used as well. However, a log domain with the basis of 2 is better for an implementation on a fixed-point signal processor. The output of the scale factor calculator 110 is a first set of scale factors.

As illustrated in FIG. 2, each of the blocks 112 to 115 can be bridged, i.e., the output of block 111, for example, could already be the first set of scale factors. However, all the processing operations and, particularly, the pre-emphasis operation are preferred. Thus, one could even implement the scale factor calculator by only performing steps 111 and 113 without the procedures in steps 112, 114 and 115, for example. Thus, the scale factor calculator 110 is configured for performing one or two or more of the procedures illustrated in FIG. 2 as indicated by the input/output lines connecting several blocks.

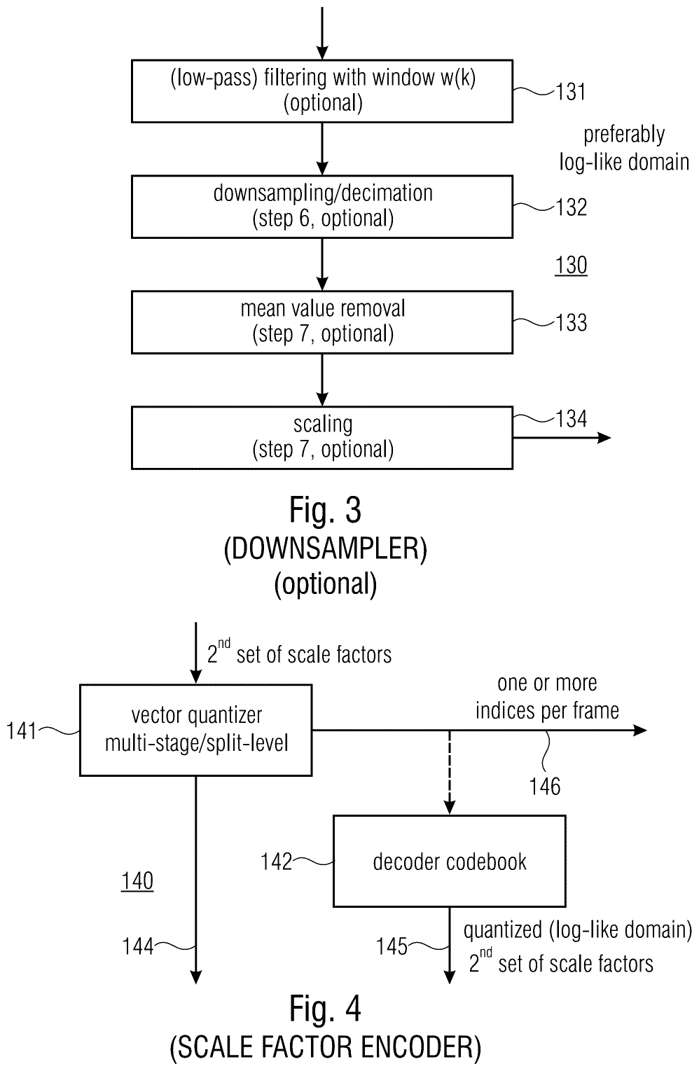

FIG. 3 illustrates a preferred implementation of the optional downsampler 130 of FIG. 1a (and FIG. 1c and FIG. 1e). Preferably, a low-pass filtering or, generally, a filtering with a certain window w(k) is performed in step 131, and, then, a downsampling/decimation operation of the result of the filtering is performed. Due to the fact that low-pass filtering 131 and in preferred embodiments the downsampling/decimation operation 132 are both arithmetic operations, the filtering 131 and the downsampling 132 can be performed within a single operation as will be outlined later on. Preferably, the downsampling/decimation operation is performed in such a way that an overlap among the individual groups of scale parameters of the first set of scale parameters is performed. Preferably, an overlap of one scale factor in the filtering operation between two decimated calculated parameters is performed. Thus, step 131 performs a low-pass filter on the vector of scale parameters before decimation. This low-pass filter has a similar effect as the spreading function used in psychoacoustic models. It reduces the quantization noise at the peaks, at the cost of an increase of quantization noise around the peaks where it is anyway perceptually masked at least to a higher degree with respect to quantization noise at the peaks.

Furthermore, the optional downsampler 130 additionally performs a mean value removal 133 and an additional scaling step 134. However, the low-pass filtering operation 131, the mean value removal step 133 and the scaling step 134 are only optional steps. Thus, the downsampler 130 illustrated in FIG. 3 or illustrated in FIG. 1a (and FIG. 1c and FIG. 1e) can be implemented to only perform step 132 or to perform two steps illustrated in FIG. 3 such as step 132 and one of the steps 131, 133 and 134. Alternatively, the downsampler can perform all four steps or only three steps out of the four steps illustrated in FIG. 3 as long as the downsampling/decimation operation 132 is performed. As outlined in FIG. 3, audio operations in FIG. 3 performed by the downsampler are performed in the log-like domain in order to obtain better results.

FIG. 4 illustrates a preferred implementation of the scale factor encoder 140. The scale factor encoder 140 receives the preferably log-like domain second set of scale factors and performs a vector quantization as illustrated in block 141 to finally output one or more indices per frame. These one or more indices per frame can be forwarded to the output interface and written into the bitstream, i.e., introduced into the output encoded audio signal 170 by means of any available output interface procedures. Preferably, the vector quantizer 141 additionally outputs the quantized log-like domain second set of scale factors. Thus, this data can be directly output by block 141 as indicated by arrow 144. However, alternatively, a decoder codebook 142 is also available separately in the encoder. This decoder codebook receives the one or more indices per frame and derives, from these one or more indices per frame the quantized preferably log-like domain second set of scale factors as indicated by line 145. In typical implementations, the decoder codebook 142 will be integrated within the vector quantizer 141. Preferably, the vector quantizer 141 is a multi-stage or split-level or a combined multi-stage/split-level vector quantizer as is, for example, used in any of the indicated prior art procedures.

Thus, it is made sure that the second set of scale factors are the same quantized second set of scale factors that are also available on the decoder-side, i.e., in the decoder that only receives the encoded audio signal that has the one or more indices per frame as output by block 141 via line 146.

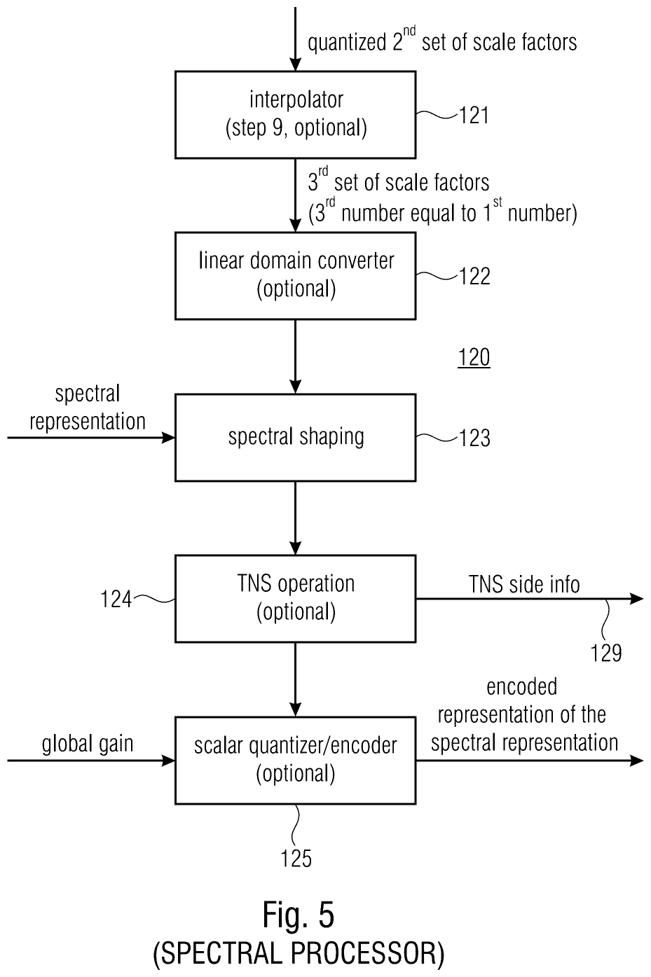

FIG. 5 illustrates a preferred implementation of the spectral processor 120. The spectral processor 120 included within the encoder 300a of FIG. 1a or 300b of FIG. 1b (or any 300c-300e in FIGS. 1c-1e) comprises an interpolator 121 that receives the quantized second set of scale parameters and that outputs the third set of scale parameters where the third number is greater than the second number and preferably equal to the first number. Furthermore, the spectral processor comprises a linear domain converter 120. Then, a spectral shaping is performed in block 123 using the linear scale parameters on the one hand and the spectral representation on the other hand that is obtained by the converter 100. Preferably, a subsequent temporal noise shaping operation, i.e., a prediction over frequency is performed in order to obtain spectral residual values at the output of block 124, while the TNS side information is forwarded to the output interface as indicated by arrow 129.

Finally, the spectral processor 120 has a scalar quantizer/encoder 125 that is configured for receiving a single global gain for the whole spectral representation, i.e., for a whole frame. Preferably, the global gain is derived depending on certain bitrate considerations. Thus, the global gain is set so that the encoded representation of the spectral representation generated by block 125 fulfils certain requirements such as a bitrate requirement, a quality requirement or both. The global gain can be iteratively calculated or can be calculated in a feed forward measure as the case may be. Generally, the global gain is used together with a quantizer and a high global gain typically results in a coarser quantization where a low global gain results in a finer quantization. Thus, in other words, a high global gain results in a higher quantization step size while a low global gain results in a smaller quantization step size when a fixed quantizer is obtained. However, other quantizers can be used as well together with the global gain functionality such as a quantizer that has some kind of compression functionality for high values, i.e., some kind of non-linear compression functionality so that, for example, the higher values are more compressed than lower values. The above dependency between the global gain and the quantization coarseness is valid, when the global gain is multiplied to the values before the quantization in the linear domain corresponding to an addition in the log domain. If, however, the global gain is applied by a division in the linear domain, or by a subtraction in the log domain, the dependency is the other way round. The same is true, when the “global gain” represents an inverse value. Alternatively the spectral processor 120 may use vector quantizer instead of the scalar quantizer.

Subsequently, preferred implementations of the individual procedures described with respect to FIG. 1a to FIG. 5 are given.

### DETAILED STEP-BY-STEP DESCRIPTION OF PREFERRED EMBODIMENTS

Here below, non-limiting examples are provided.

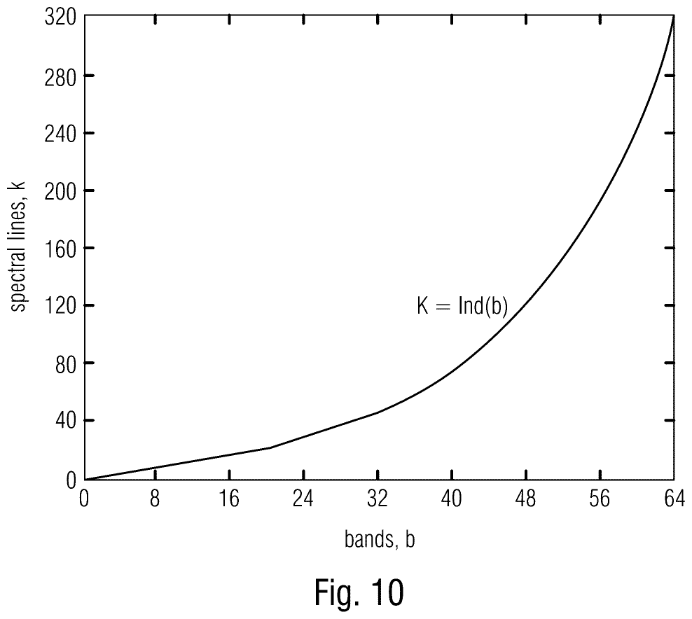

The signal 160 may be converted into multiple bands (e.g. N_{B} bands, e.g. N_{B}=64, but a different number ca be used). For each band a plurality of spectral lines (indexes, bins) may be defined. An example is shown in FIG. 10 (see also below), showing that the generic b-th band may be associated with a variable number of multiple indexes. A function Ind(b) maps the b-th band onto the first spectral line Ind(b) of the b-th band. The b-th band is therefore associated with an interval of spectral lines defined as [Ind(b), Ind(b+1)−1). The bands may be non-uniform and follow the perceptually-relevant bark scale (smaller in low-frequencies, larger in high-frequencies).

The mapping from b to Ind(b) is shown in FIG. 10 (see also below). As defined by LC3, Ind(b) may be that defined by the tables in the LC3 specification in sections 3.7.1 and 3.7.2; there are table for different sampling rates; FIG. 10 shows the mapping for I_32000 from 3.7.1 in the LC3 specification.

### Encoder:

### Step 1: Energy Per Band (111)

The energies per band E_{B}(n) are computed as follows:

$${E}_{B} ( b ) = {\sum }_{k = Ind ( b )}^{Ind ( b + 1 ) - 1} \frac{{X ( k )}^{2}}{Ind ( b + 1 ) - Ind ( b )} for b = 0 .. {N}_{B} - 1$$

with X(k) are the MDCT (or MDST) coefficients (or other coefficients, e.g. other coefficients of another real-valued transform), N_{B}=64 is the number of bands and k (with k between Ind(b) and Ind(b+1)−1) are the indexes of spectral lines of the b-th band, and Ind(b+1)−Ind(b) is the width (in number of coefficients) of the b-th band (the energy per band is therefore normalized by the width of each band). The bands may be non-uniform and follow the perceptually-relevant bark scale (smaller in low-frequencies, larger in high-frequencies). The lowest band is b=0, the highest b=63=N_{B}−1 (as explained above, N_{B} may be different from 64).

It is to be noted that a version without dividing by the number of the indexes may also be performed. Hence, the formula

$${E}_{B} ( b ) = {Σ}_{k = I n d ( b )}^{I n d ( b + 1 ) - 1} \frac{{X ( k )}^{2}}{I n d ( b + 1 ) - I n d ( b )}$$

may be substituted by:

$${E}_{B} ( b ) = {\sum }_{k = I n d ( b )}^{I n d ( b + 1 ) - 1} {X ( k )}^{2} for b = 0 … {N}_{B} - 1$$

(Notably, the energy per band is not normalized by the width of the band).

It is in addition or in alternative possible to compute the energies per band E_{B}(n):

$${E}_{B} ( b ) = {\sum }_{k = I n d ( b )}^{I n d ( b + 1 ) - 1} \frac{{X ( k )}^{2} + {Y ( k )}^{2}}{Ind ( b + 1 ) - Ind ( b )} for b = 0 … {N}_{B} - 1$$

with X(k) being MDCT coefficients, with Y(k) being MDST coefficients at the same k-th index, N_{B}=64 is the number of bands and k (with k between Ind(b) and Ind(b+1)−1) are the indexes of spectral lines of the b-th band, and Ind(b+1)−Ind(b) is the width (in number of coefficients) of the b-th band (the the energy per band is therefore normalized by the width of the band). The bands may be non-uniform and follow the perceptually-relevant bark scale (smaller in low-frequencies, larger in high-frequencies). The lowest band is b=0, the highest b=63=N_{B}−1 (as explained above, N_{B} may be different from 64).

As above, the formula

$${E}_{B} ( b ) = {Σ}_{k = I n d ( b )}^{I n d ( b + 1 ) - 1} \frac{{X ( k )}^{2} + {Y ( k )}^{2}}{I n d ( b + 1 ) - I n d ( b )}$$

may be substituted by

$${E}_{B} ( b ) = {\sum }_{k = I n d ( b )}^{I n d ( b + 1 ) - 1} [ {X ( k )}^{2} + {Y ( k )}^{2} ] for b = 0 … {N}_{B} - 1$$

It is to be noted that the formula E_{B}(b)=Σ_{k=Ind(b)}^{Ind(b+1)-1}[X(k)²+Y(k)²] for b=0 . . . N_{B}−1 can be understood, in pseudocode, as:

```
for b = 0..63:
  E_{B}(b) = 0
  for k = Ind(b)..Ind(b+1)−1:
    E_{B}(b) = E_{B}(b) + X(k)² + Y(k)²
```

### Step 2: Smoothing (112)

The energy per band E_{B}(b) is smoothed using

$${E}_{S} ( b ) = \{ \begin{matrix}0.75 \cdot {E}_{B} ( 0 ) + 0.25 \cdot {E}_{B} ( 1 ) & , if b = 0 \\ 0.25 \cdot {E}_{B} ( 62 ) + 0.75 \cdot {E}_{B} ( 63 ) & , if b = 63 \\ 0.25 \cdot {E}_{B} ( b - 1 ) + 0.5 \cdot {E}_{B} ( b ) + 0.25 \cdot {E}_{B} ( b + 1 ) & , otherwise\end{matrix}$$

Remark: this step is mainly used to smooth the possible instabilities that can appear in the vector E_{B}(b). If not smoothed, these instabilities are amplified when converted to log-domain (see step 5), especially in the valleys where the energy is close to 0.

### Step 3: Pre-Emphasis (113)

The smoothed energy per band E_{S}(b) is then pre-emphasized using

$${E}_{P} ( b ) = {E}_{S} ( b ) \cdot {10}^{\frac{b \cdot {g}_{tilt} \cdot {g}^{′}}{10 \cdot 63}} for b = 0 … 63$$

with gₜᵢₗₜ (which in some examples can be avoided) controls the pre-emphasis tilt and depends on the bandwidth of the audio signal 160 (bandwidth of the spectral representation, the sampling frequency corresponding to the spectral representation). gₜᵢₗₜ is for example 15.75 for 8 kHz bandwidth of the spectral representation, 18.375 for 12.8 kHz bandwidth of the spectral representation and 19.5 for 16 kHz bandwidth of the spectral representation. g′ is the harmonicity measure 163.

A more general definition may be

$${E}_{p} ( b ) = {E}_{S} ( b ) \cdot {d}^{( \frac{b \cdot {g}_{tilt} \cdot {g}^{′}}{h \cdot nb} )} ,$$

where the

$$\frac{b \cdot {g}_{tilt} \cdot {g}^{′}}{h \cdot nb}$$

is an exponent applied to d>0; h is fixed (e.g. equal to 10), g′≥0 is, or is derived from, the harmonicity measure 163, gₜᵢₗₜ is pre-defined (e.g. dependent on the spectral representation bandwidth), b is an index indicating the band out of N_{B} bands (e.g. N_{B}=64 or a different number).

It is here distinguished between:
A pre-emphasis factor

$${d}^{( \frac{b \cdot {g}_{tilt} \cdot {g}^{′}}{h \cdot nb} )} ( e . g . {10}^{\frac{b \cdot {g}_{tilt} \cdot {g}^{′}}{10 \cdot 63}} )$$

which is applied to the energy per band E_{S}(b) (the higher the pre-emphasis factor, the higher the pre-emphasis)
A tilt value

$$\frac{b \cdot {g}_{tilt} \cdot {g}^{′}}{h \cdot nb} ( e . g . \frac{b \cdot {g}_{tilt} \cdot {g}^{′}}{10 \cdot 63} )$$

which is an exponent to be applied to d>0 (e.g. d=10) (the higher the tilt value, the higher the pre-emphasis)
A tilt factor gₜᵢₗₜ e.g. based on the bandwidth (the higher the tilt factor, the higher the pre-emphasis)
A harmonicity value g′ (163, e.g. 163′ or 163″) (the higher the harmonicity value, the higher the pre-emphasis)
The number N_{B} of bands (e.g. 64, or a different number)
The band index b (e.g. between 0 and N_{B}−1).

The pre-emphasis used in this step may have an analogous purpose as the pre-emphasis used in the LPC-based perceptual filter of prior art 2, it increases the amplitude of the shaped Spectrum in the low-frequencies, resulting in reduced quantization noise in the low-frequencies.

### Step 4: Noise Floor (114)

A noise floor at −40 dB is added to E_{P}(b) using

E_{P}(b)=max(E_{P}(b),noiseFloor) for b=0 . . . 63

with the noise floor being calculated by

$$noiseFloor = max ( \frac{{\sum }_{b = 0}^{63} {E}_{P} ( b )}{64} \cdot {10}^{- \frac{40}{10}} , 1 {0}^{- 7} )$$

This step improves quality of signals containing very high spectral dynamics such as e.g. glockenspiel, by limiting the amplitude amplification of the shaped spectrum in the valleys, which has the indirect effect of reducing the quantization noise in the peaks, at the cost of an increase of quantization noise in the valleys where it is anyway not perceptible.

### Step 5: Logarithm (115)

A transformation into the logarithm domain is then performed using

$${E}_{L} ( b ) = \frac{{log}_{2} ( {E}_{P} ( b ) )}{2} for b = 0 … 63$$

### Step 6: Downsampling (131, 132)

The vector E_{L}(b) is then downsampled by a factor of 4 using

$${E}_{4} ( b ) = \{ \begin{matrix}w ( 0 ) {E}_{L} ( 0 ) + {\sum }_{k = 1}^{5} w ( k ) {E}_{L} ( 4 b + k - 1 ) & , if b = 0 \\ {\sum }_{k = 0}^{4} w ( k ) {E}_{L} ( 4 b + k - 1 ) + w ( 5 ) {E}_{L} ( 63 ) & , if b = 15 \\ {\sum }_{k = 0}^{5} w ( k ) {E}_{L} ( 4 b + k - 1 ) & , otherwise\end{matrix}$$

$$with w ( k ) = \{ \frac{1}{12} , \frac{2}{12} , \frac{3}{12} , \frac{3}{12} , \frac{2}{12} , \frac{1}{12} \}$$

This step applies a low-pass filter (w(k)) on the vector E_{L}(b) before decimation. This low-pass filter has a similar effect as the spreading function used in psychoacoustic models: it reduces the quantization noise at the peaks, at the cost of an increase of quantization noise around the peaks where it is anyway perceptually masked.

### Step 7: Mean Removal and Scaling (133, 134)

The final scale factors are obtained after mean removal and scaling by a factor of 0.85

$$scf ( n ) = 0.85 ( {E}_{4} ( n ) - \frac{{\sum }_{b = 0}^{15} {E}_{4} ( b )}{16} ) for n = 0 … 15$$

Since the codec has an additional global-gain, the mean can be removed without any loss of information. Removing the mean also allows more efficient vector quantization.

The scaling of 0.85 slightly compress the amplitude of the noise shaping curve. It has a similar perceptual effect as the spreading function mentioned in Step 6: reduced quantization noise at the peaks and increased quantization noise in the valleys.

### Step 8: Quantization (141, 142)

The scale factors are quantized using vector quantization, producing indices which are then packed into the bitstream and sent to the decoder, and quantized scale factors scfQ(n).

### Step 9: Interpolation (121, 122)

The quantized scale factors scfQ(n) are interpolated using

$$scfQint ( 0 ) = scfQ ( 0 )$$

$$scfQint ( 1 ) = scfQ ( 0 )$$

$$scfQint ( 4 n + 2 ) = scfQ ( n ) + \frac{1}{8} ( scfQ ( n + 1 ) - scfQ ( n ) ) for n = 0 .. 14$$

$$scfQint ( 4 n + 3 ) = scfQ ( n ) + \frac{3}{8} ( scfQ ( n + 1 ) - scfQ ( n ) ) for n = 0 .. 14$$

$$scfQint ( 4 n + 4 ) = scfQ ( n ) + \frac{5}{8} ( scfQ ( n + 1 ) - scfQ ( n ) ) for n = 0 .. 14$$

$$scfQint ( 4 n + 5 ) = scfQ ( n ) + \frac{7}{8} ( scfQ ( n + 1 ) - scfQ ( n ) ) for n = 0 .. 14$$

$$scfQint ( 62 ) = scfQ ( 15 ) + \frac{1}{8} ( scfQ ( 15 ) - scfQ ( 14 ) )$$

$$scfQint ( 63 ) = scfQ ( 15 ) + \frac{3}{8} ( scfQ ( 15 ) - scfQ ( 14 ) )$$

and transformed back into linear domain using

g_{SNS}(b)=2^{scfQint(b)} for b=0 . . . 63

Interpolation is used to get a smooth noise shaping curve and thus to avoid any big amplitude jumps between adjacent bands.

### Step 10: Spectral Shaping (123)

The SNS scale factors g_{SNS}(b) are applied on the MDCT frequency lines for each band separately in order to generate the shaped spectrum Xₛ(k)

$${X}_{s} ( k ) = \frac{X ( k )}{{g}_{SNS} ( b )} for k = Ind ( b ) .. Ind ( b + 1 ) - 1 , for b = 0 .. 63$$

This expression can be read, in pseudocode, as:

```
for b = 0..63:
  for k = Ind(b)..Ind(b+1)−1:
    ${X}_{s} ( k ) = \frac{X ( k )}{{g}_{SNS} ( b )}$
```

The scale parameters g_{SNS}(b) may be outputted by block 122 and used by block 123 in FIG. 5.

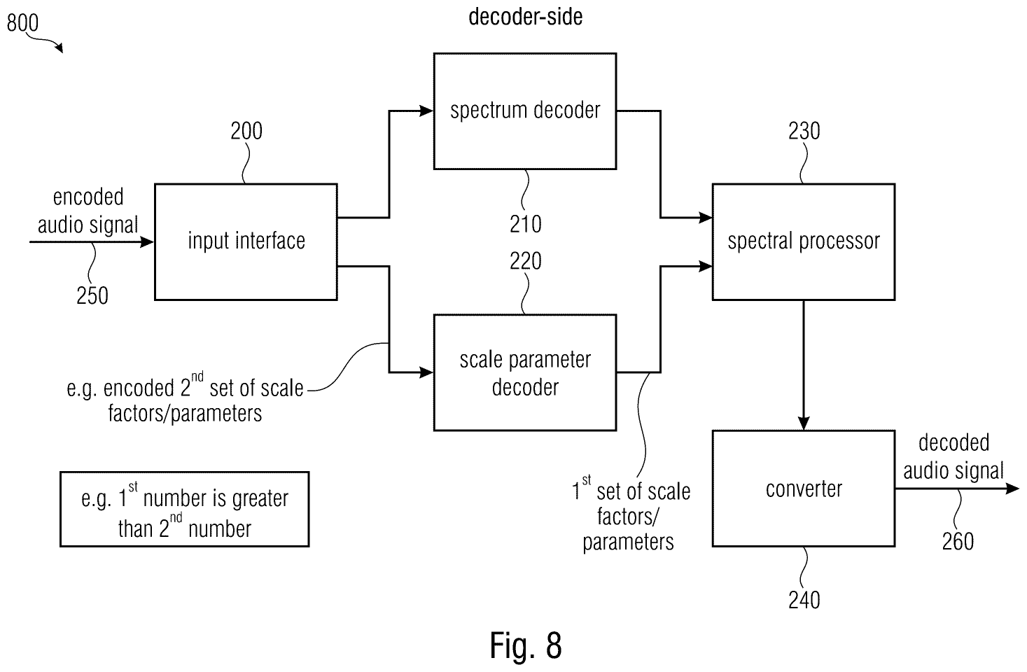

FIG. 8 illustrates a preferred implementation of an apparatus 800 for decoding an encoded audio signal 250 comprising information on an encoded spectral representation and information on an encoded representation of a second set of scale parameters. The decoder 800 comprises an input interface 200, a spectrum decoder 210, a scale factor/parameter decoder 220, a spectral processor 230 and a converter 240. The input interface 200 is configured for receiving the encoded audio signal 250 and for extracting the encoded spectral representation that is forwarded to the spectrum decoder 210 and for extracting the encoded representation of the second set of scale factors that is forwarded to the scale factor decoder 220. Furthermore, the spectrum decoder 210 is configured for decoding the encoded spectral representation to obtain a decoded spectral representation that is forwarded to the spectral processor 230. The scale factor decoder 220 is configured for decoding the encoded second set of scale parameters to obtain a first set of scale parameters forwarded to the spectral processor 230. The first set of scale factors has a number of scale factors or scale parameters that is greater than the number of scale factors or scale parameters in the second set. The spectral processor 230 is configured for processing the decoded spectral representation using the first set of scale parameters to obtain a scaled spectral representation. The scaled spectral representation is then converted by the converter 240 to finally obtain the decoded audio signal 260.

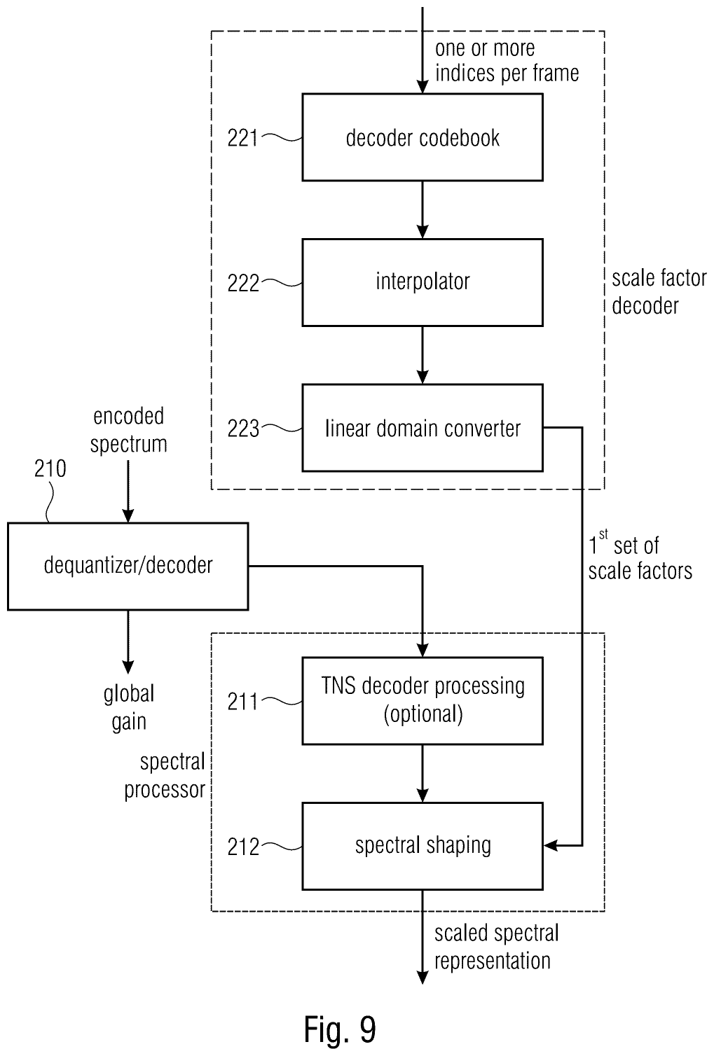

Preferably, the scale factor decoder 220 is configured to operate in substantially the same manner as has been discussed with respect to the spectral processor 120 of FIG. 1a or 1b or 1c or 1d or 1e or 1f relating to the calculation of the third set of scale factors or scale parameters as discussed in connection with blocks 141 or 142 and, particularly, with respect to blocks 121, 122 of FIG. 5. Particularly, the scale factor decoder is configured to perform the substantially same procedure for the interpolation and the transformation back into the linear domain as has been discussed before with respect to step 9. Thus, as illustrated in FIG. 9, the scale factor decoder 220 is configured for applying a decoder codebook 221 to the one or more indices per frame representing the encoded scale parameter representation. Then, an interpolation is performed in block 222 that is substantially the same interpolation as has been discussed with respect to block 121 in FIG. 5. Then, a linear domain converter 223 is used that is substantially the same linear domain converter 122 as has been discussed with respect to FIG. 5. However, in other implementations, blocks 221, 222, 223 can operate different from what has been discussed with respect to the corresponding blocks on the encoder-side.

Furthermore, the spectrum decoder 210 illustrated in FIG. 8 comprises a dequantizer/decoder block that receives, as an input, the encoded spectrum and that outputs a dequantized spectrum that is preferably dequantized using the global gain that is additionally transmitted from the encoder side to the decoder side within the encoded audio signal in an encoded form. The dequantizer/decoder 210 can, for example, comprise an arithmetic or Huffman decoder functionality that receives, as an input, some kind of codes and that outputs quantization indices representing spectral values. Then, these quantization indices are input into a dequantizer together with the global gain and the output are dequantized spectral values that can then be subjected to a TNS processing such as an inverse prediction over frequency in a TNS decoder processing block 211 that, however, is optional. Particularly, the TNS decoder processing block additionally receives the TNS side information that has been generated by block 124 of FIG. 5 as indicated by line 129. The output of the TNS decoder processing step 211 is input into a spectral shaping block 212, where the first set of scale factors as calculated by the scale factor decoder are applied to the decoded spectral representation that can or cannot be TNS processed as the case may be, and the output is the scaled spectral representation that is then input into the converter 240 of FIG. 8.

Further procedures of preferred embodiments of the decoder are discussed subsequently.

### Decoder:

### Step 1: Quantization (221)

The vector quantizer indices produced in encoder step 8 are read from the bitstream and used to decode the quantized scale factors scfQ(n).

### Step 2: Interpolation (222, 223)

Same as Encoder Step 9.

### Step 3: Spectral Shaping (212)

The SNS scale factors g_{SNS}(b) are applied on the quantized MDCT frequency lines for each band separately in order to generate the decoded spectrum \hat{X}(k) as outlined by the following code.

\hat{X}(k)= [symbol] (k)·g_{SNS}(b) for k=Ind(b) . . . Ind(b+1)−1, for b=0 . . . 63

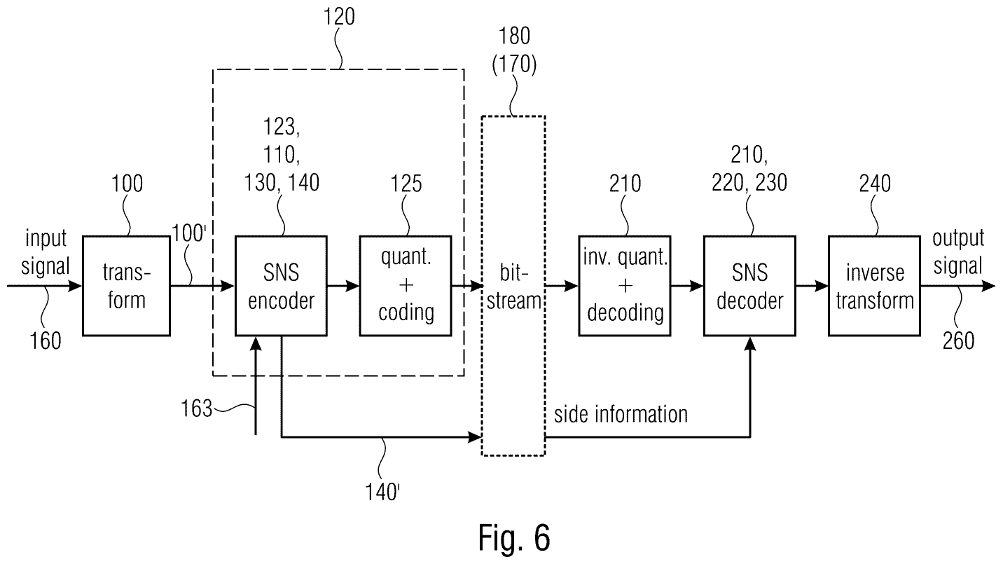

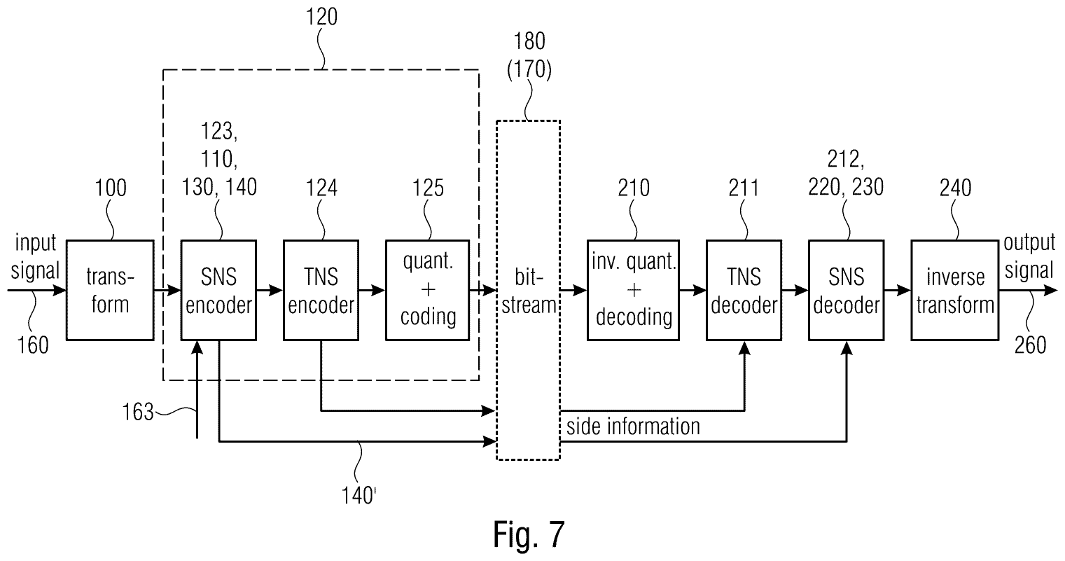

FIG. 6 and FIG. 7 illustrate a general encoder/decoder setup where FIG. 6 represents an implementation without TNS processing, while FIG. 7 illustrates an implementation that comprises TNS processing. Similar functionalities illustrated in FIG. 6 and FIG. 7 correspond to similar functionalities in the other figures when identical reference numerals are indicated. Particularly, as illustrated in FIG. 6, the input signal 160 is input into a transform stage 110 and, subsequently, the spectral processing 120 is performed. Particularly, the spectral processing is reflected by an SNS encoder indicated by reference numerals 123, 110, 130, 140 indicating that the block SNS encoder implements the functionalities indicated by these reference numerals. Subsequently to the SNS encoder block, a quantization encoding operation 125 is performed, and the encoded signal is input into the bitstream as indicated at 180 in FIG. 6. The bitstream 180 (which may be an example of output encoded audio signal) then occurs at the decoder-side and subsequent to an inverse quantization and decoding illustrated by reference numeral 210, the SNS decoder operation illustrated by blocks 210, 220, 230 of FIG. 8 are performed so that, in the end, subsequent to an inverse transform 240, the decoded output signal 260 is obtained.

FIG. 7 illustrates a similar representation as in FIG. 6, but it is indicated that, preferably, the TNS processing is performed subsequent to SNS processing on the encoder-side and, correspondingly, the TNS processing 211 is performed before the SNS processing 212 with respect to the processing sequence on the decoder-side.

Preferably the additional tool TNS between Spectral Noise Shaping (SNS) and quantization/coding (see block diagram below) is used. TNS (Temporal Noise Shaping) also shapes the quantization noise but does a time-domain shaping (as opposed to the frequency-domain shaping of SNS) as well. TNS is useful for signals containing sharp attacks and for speech signals.

TNS is usually applied (in AAC for example) between the transform and SNS. Preferably, however, it is preferred to apply TNS on the shaped spectrum. This avoids some artifacts that were produced by the TNS decoder when operating the codec at low bitrates.

FIG. 10 illustrates a preferred subdivision of the spectral coefficients or spectral lines as obtained by block 100 on the encoder-side into bands. Particularly, it is indicated that lower bands have a smaller number of spectral lines than higher frequency bands. Particularly, the x-axis in FIG. 10 corresponds to the index of bands and illustrates the preferred embodiment of 64 bands and the y-axis corresponds to the index of the spectral lines illustrating 320 spectral coefficients in one frame. Particularly, FIG. 10 illustrates exemplarily the situation of the super wide band (SWB) case where there is a spectral representation bandwidth of 16 kHz. For the wide band case, the situation with respect to the individual bands is so that one frame results in 160 spectral lines and the spectral representation bandwidth is 8 kHz so that, for both cases, one frame has a length in time of 10 milliseconds.

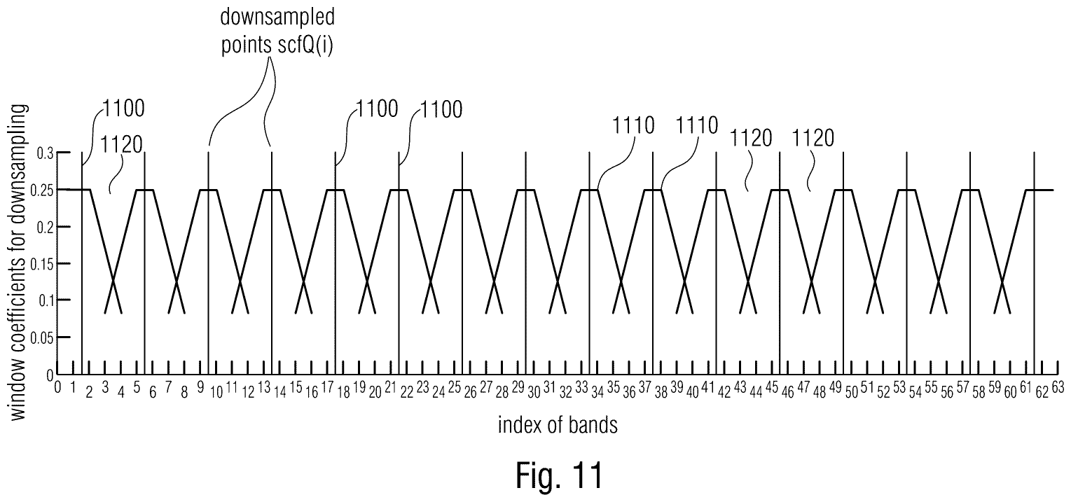

FIG. 11 illustrates more details on the preferred downsampling performed in the downsampler 130 of FIG. 1a (or 1c or 1e) or the corresponding upsampling or interpolation as performed in the scale factor decoder 220 of FIG. 8 or as illustrated in block 222 of FIG. 9.

Along the x-axis, the index for the bands 0 to 63 is given. Particularly, there are 64 bands going from 0 to 63.

The 16 downsample points corresponding to scfQ(i) are illustrated as vertical lines 1100. Particularly, FIG. 11 illustrates how a certain grouping of scale parameters is performed to finally obtain the downsampled point 1100. Exemplarily, the first block of four bands consists of (0, 1, 2, 3) and the middle point of this first block is at 1.5 indicated by item 1100 at the index 1.5 along the x-axis.

Correspondingly, the second block of four bands is (4, 5, 6, 7), and the middle point of the second block is 5.5.

The windows 1110 correspond to the windows w(k) discussed with respect to the step 6 downsampling described before. It can be seen that these windows are centered at the downsampled points and there is the overlap of one block to each side as discussed before.

The interpolation step 222 of FIG. 9 recovers the 64 bands from the 16 downsampled points. This is seen in FIG. 11 by computing the position of any of the lines 1120 as a function of the two downsampled points indicated at 1100 around a certain line 1120. The following example exemplifies that.

The position of the second band is calculated as a function of the two vertical lines around it (1.5 and 5.5):2=1.5+(⅛)*(5.5−1.5).

Correspondingly, the position of the third band as a function of the two vertical lines 1100 around it (1.5 and 5.5): 3=1.5+(⅜)*(5.5−1.5).

A specific procedure is performed for the first two bands and the last two bands. For these bands, an interpolation cannot be performed, because there would not exist vertical lines or values corresponding to vertical lines 1100 outside the range going from 0 to 63. Thus, in order to address this issue, an extrapolation is performed as described with respect to step 9: interpolation as outlined before for the two bands 0, 1 on the one hand and 62 and 63 on the other hand.

Subsequently, a preferred implementation of the converter 100 of FIG. 1a or 1b or 1c or 1d or 1e or 1f on the one hand and the converter 240 of FIG. 8 on the other hand are discussed.

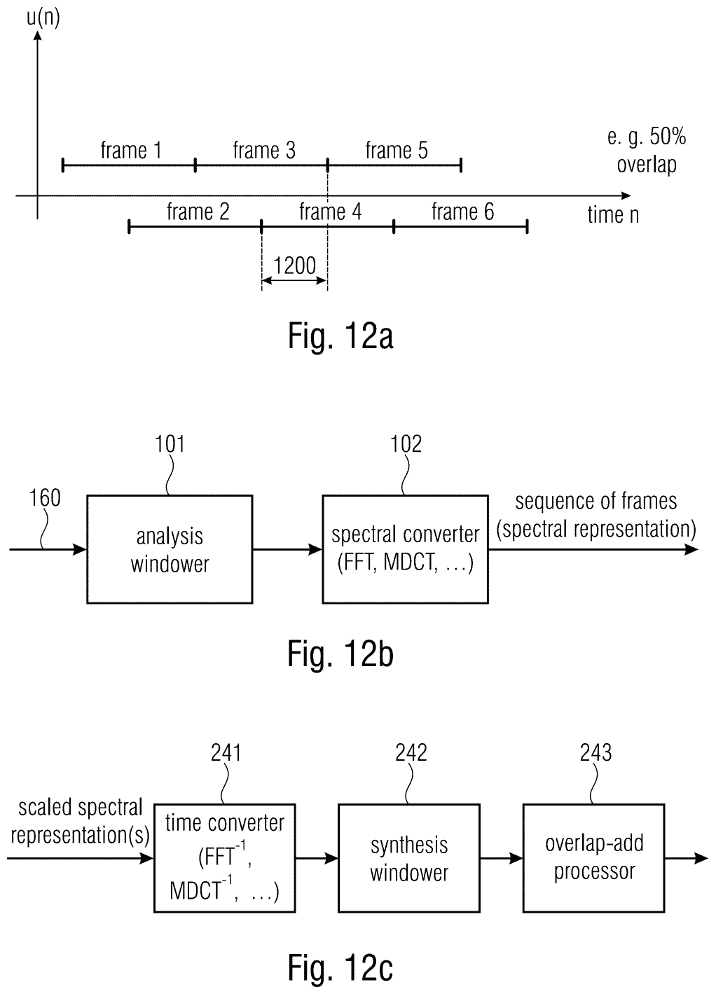

Particularly, FIG. 12a illustrates a schedule for indicating the framing performed on the encoder-side within converter 100. FIG. 12b illustrates a preferred implementation of the converter 100 of FIG. 1a or 1b or 1c or 1d or 1e or 1f on the encoder-side and FIG. 12c illustrates a preferred implementation of the converter 240 on the decoder-side.

The converter 100 on the encoder-side is preferably implemented to perform a framing with overlapping frames such as a 50% overlap so that frame 2 overlaps with frame 1 and frame 3 overlaps with frame 2 and frame 4. However, other overlaps or a non-overlapping processing can be performed as well, but it is preferred to perform a 50% overlap together with an MDCT algorithm. To this end, the converter 100 comprises an analysis window 101 and a subsequently-connected spectral converter 102 for performing an FFT processing, an MDCT processing or any other kind of time-to-spectrum conversion processing to obtain a sequence of frames corresponding to a sequence of spectral representations as input in FIG. 1a or 1b or 1c or 1d or 1e or if to the blocks subsequent to the converter 100.

Correspondingly, the scaled spectral representation(s) are input into the converter 240 of FIG. 8. Particularly, the converter comprises a time-converter 241 implementing an inverse FFT operation, an inverse MDCT operation or a corresponding spectrum-to-time conversion operation. The output is inserted into a synthesis window 242 and the output of the synthesis window 242 is input into an overlap-add processor 243 to perform an overlap-add operation in order to finally obtain the decoded audio signal. Particularly, the overlap-add processing in block 243, for example, performs a sample-by-sample addition between corresponding samples of the second half of, for example, frame 3 and the first half of frame 4 so that the audio sampling values for the overlap between frame 3 and frame 4 as indicated by item 1200 in FIG. 12a is obtained. Similar overlap-add operations in a sample-by-sample manner are performed to obtain the remaining audio sampling values of the decoded audio output signal.

### Pre-Emphasis and Tilt

Here, the pre-emphasis as controlled by the tilt (and in turn by the harmonicity measure 163 of the signal 160), e.g. at block 113, is discussed. While it is often referred to “energy per band”, this concept can be generalized to “amplitude-related measure”.

The pre-emphasis (113) has the purpose of increasing the amplitude of the spectrum (e.g. as outputted by the converter 100, or a processed version thereof) in the low-frequencies, resulting in reduced quantization noise in the low-frequencies. By using the harmonicity measure 163 to control the pre-emphasis spectral tilt, the increase of the amplitude of the spectrum is controlled in the low-frequencies in function of the harmonicity 163 of the audio signal 160. So, in general terms if the audio signal 160 is highly harmonic (e.g. is mostly speech) the amplitude of the spectrum is increased at low frequencies (e.g. normally voiced speech) in respect to the high frequencies (e.g. mostly noise), whose spectrum's amplitude is decreased.

If the audio signal 160 is weakly harmonic (e.g. is mostly noise), then:
the lower-frequency part of the spectrum increases for a less extent (or not at all) than in the case of the audio signal 160 being highly harmonic, and
the higher-frequency part of the spectrum decreases for a less extent (or not at all) than in the case of highly harmonic signal, compared to the lower frequencies.

Due to the present techniques, the spectral tilt increases or decreases based on the harmonicity measure 163, so that a lower harmonicity (163) implies a lower tilt (and a higher harmonicity, 163, implies higher tilt).

An example of a pre-emphasis using a spectral tilt is provided by the above shown formula

$${E}_{P} ( b ) = {E}_{S} ( b ) \cdot {10}^{\frac{b \cdot {g}_{tilt} \cdot g ′}{10 \cdot 63}} for b = 0 .. 63$$

with g′ being a representation of the harmonicity measure 163. That formula may be generalized into

$${E}_{p} ( b ) = {E}_{s} ( b ) \cdot {d}^{( \frac{b \cdot {g}_{tilt} \cdot g ′}{h \cdot nb} )} ,$$

where the tilt value

$$\frac{b \cdot {g}_{tilt} \cdot {g}^{′}}{h \cdot nb}$$

is an exponent applied to d, h is fixed, g′≥0 is, or is derived from, the harmonicity measure, gₜᵢₗₜ≠0 is pre-defined, b is an index indicating the band out of N_{B} bands. The pre-emphasis factor

$${d}^{( \frac{b \cdot {g}_{tilt} \cdot {g}^{′}}{h \cdot nb} )}$$

(or more frequently

$${10}^{( \frac{b \cdot {g}_{tilt} \cdot g ′}{10 \cdot nb} )} ,$$

e.g.

$${10}^{( \frac{b \cdot {g}_{tilt} \cdot g ′}{10 \cdot 63} )} ) ,$$

where

$$\frac{b \cdot {g}_{tilt} \cdot g ′}{h \cdot nb}$$

(tilt value) is an exponent
applied e.g. to d (e.g. d=10), h (e.g. h=10) is fixed, g′≥0 (e.g. 0≤g′≤1) is, or is derived from, the harmonicity, gₜᵢₗₜ≠0 is pre-defined and may be, in general, dependent on the bandwidth of the spectral representation 100′ (e.g. gₜᵢₗₜ may be higher for higher bandwidths), b is an index indicating the band out of nb+1 bands. A more common notation is

$${10}^{( \frac{b \cdot {g}_{tilt} \cdot g ′}{h \cdot nb} )} ,$$

which is the same of before but the exponentiation has base 10. The pre-emphasis is then applied to the spectral energy E_{S}(b), so as to have a pre-emphasized energy information

$${E}_{p} ( b ) = {E}_{s} ( b ) \cdot {d}^{( \frac{b \cdot {g}_{tilt} \cdot g ′}{h \cdot nb} )} .$$

The bands are in general indexed by an index b which may be between a lower index (e.g. 0) to indicate a low frequency (e.g. DC in case of 0) and increases up to a maximum index (e.g. equal to nb, which may be, for example, 63, in the case that the signal is subdivided into N_{B}=64 bands, but different number of bands are possible).

In examples, the higher the harmonicity, the higher g′ (which may be understood as the harmonicity measure 163), the higher the spectral tilt, the more precise the quantizing of the lower frequencies of the shaped spectrum with more detail with respect to the higher frequencies.

Often the control of the spectral tilt reduces the spectral tilt with respect to a fixed value, since a weight between 0 and 1 may be applied (e.g., 0 for a completely noisy or transient signal, and 1, or another value greater than zero, for a totally harmonic signal). This may be obtained, for example, by weighting the tilt using a normalized value, such as a normalized harmonicity. Therefore, g′ may be a normalized version of the harmonicity 163 and may take a value between 0 and 1.

The harmonicity measure 163 may be obtained by autocorrelating the input signal 160, e.g. along one frame. It may be, for example, a normalized autocorrelation.

It is to be noted that the scaling of the spectral (pre-emphasize) tilt might slightly increase the computational effort, since a scaling by g′ (harmonicity or, more in general, harmonicity-related measurement) is carried out, for example. However, when calculating

$${E}_{p} ( b ) = {E}_{s} ( b ) \cdot {d}^{\frac{b \cdot {g}_{tilt} \cdot {g}^{′}}{h \cdot nb}}$$

for b=0 . . . nb, it is possible to calculate the exponent

$$\frac{b \cdot {g}_{tilt} \cdot {g}^{′}}{h \cdot nb}$$

by:
1) First, calculating the term

$$\frac{{g}_{tilt} \cdot {g}^{′}}{h \cdot nb}$$

(common all bands);
2) Second, for each band, scaling the obtained term

$$\frac{{g}_{tilt} {g}^{′}}{h \cdot nb}$$

by the band index b, to thereby obtain the tilt value (g′ is constant within the frame).

Therefore, the increase in computational effort is not overwhelming. Indeed gₜᵢₗₜ and g′ are the same for all the bands in the whole frame.

Reference can now be made to Step 10 (spectral shaping). The calculation of the scale factors g_{SNS}(b) to be used for shaping the signal therefore results controlled by the spectral tilt value. It is noted that:
a comparatively higher spectral tilt results in quantizing the lower frequencies of the shaped spectrum with more detail, while
a comparatively lower spectral tilt results in quantizing the spectrum more equally over the whole spectral range.

The pre-emphasis applied by the processor 110 may therefore increase the amplitude of the shaped spectrum in the low frequencies, resulting in reduced quantization noise in the low-frequencies. Using e.g. harmonicity measure 163 to control the spectral tilt permits to adapt the strength of this effect to the features of the audio signal 160. So, if the audio signal 160 is highly-harmonic, the effect is increasing the amplitude of the shaped spectrum at low frequencies, so that there is reduced quantization noise, and if the mono audio signal 602 is non-harmonic there is applied a less strong spectral tilt on the shaped energies (the lower-frequency part of the spectrum is not amplified too much or not at all compared to the higher frequencies), hence permitting to quantize more evenly over the whole spectrum.

Several techniques may be used for acquiring the harmonicity measure 163. For example, the harmonicity measure 163 may be an LTP (long term predictor) parameter or an LTPF (long term post-filter) parameter, so that the scale parameter calculator 110 controls the tilt based on an LTP parameter or an LTPF parameter as the harmonicity measure of the audio signal 160. In addition or alternative, the harmonicity measure 163 may be a spectral flatness measure of the audio signal 160, so that the scale parameter calculator 110 controls the tilt based on the spectral flatness measure. Notably, the harmonicity measure 163 may be encoded anyway in the output encoded audio signal 170, e.g. for other reasons (e.g., as LTP or LTPF parameter and/or for the purpose of performing packet loos concealment at the decoder). For this reason, the harmonicity measure 163 may be quantized, and its quantized version may be used as g′ for controlling the tilt. In addition or alternative, the harmonicity measure 163 may be normalized (e.g. between 0 and 1, as discussed above), so as to control the tilt based on a normalized version of the harmonicity measure 163 of the audio signal 160.

As explained above, the obtained set of amplitude-related measures may be preferably a set of energies per bands Eₚ(b), e.g. obtained through Eₚ(b)=E_{S}(b).

$$\\ {d}^{{}_{} ( \frac{b \cdot {g}_{{}_{} tilt} \cdot {g}^{{}_{} ′}}{{}^{} h \cdot nb} )} ,$$

where

$$\\ \frac{b \cdot {g}_{tilt} \cdot {g}^{{}_{} ′}}{h \cdot nb}$$

is an exponent applied to d (e.g. d>1), h (e.g. h>0) is fixed, g′≥0 is the harmonicity measure, gₜᵢₗₜ>0 is pre-defined, b is an index indicating the band out of N_{B} bands in such a way that a higher frequency band has a higher index than a lower frequency band.

In general terms, the tilt value

$$\\ ( e . g . \frac{b \cdot {g}_{tilt} \cdot {g}^{{}_{} ′}}{h \cdot nb} )$$

may be proportional (or at least linear) with the harmonicity measure (g′, 163 in the figures), where the proportionality coefficient may be

$$\\ \frac{b \cdot {g}_{tilt}}{h \cdot nb} .$$

Further, the tilt value

$$\\ ( e . g . \frac{b \cdot {g}_{tilt} \cdot {g}^{{}_{} ′}}{h \cdot nb} )$$

may be proportional (or more in general linear) with the coefficient b/nb is a value which is 0 for b=0 and 1 for the highest band and increases with the increase of the frequency of the generic b-th band (the increase is linear with the index b, but not necessarily with the frequency).

Moreover, the tilt value

$$\\ ( e . g . \frac{b \cdot {g}_{tilt} \cdot {g}^{{}_{} ′}}{h \cdot nb} )$$

may be proportional (or more in general linear) with gₜᵢₗₜ (which in some examples can be avoided), which is controlled with the sampling rate (e.g. gₜᵢₗₜ)

Therefore, the tilt value

$$\\ ( e . g . \frac{b \cdot {g}_{tilt} \cdot {g}^{{}_{} ′}}{h \cdot nb} )$$

may be proportional (or at least linear with) at least one of:
the harmonicity measure (g′, 163);
the coefficient b/nb which increases (e.g. linearly) with the increase of the frequency of the generic b-th band;
the coefficient gₜᵢₗₜ.

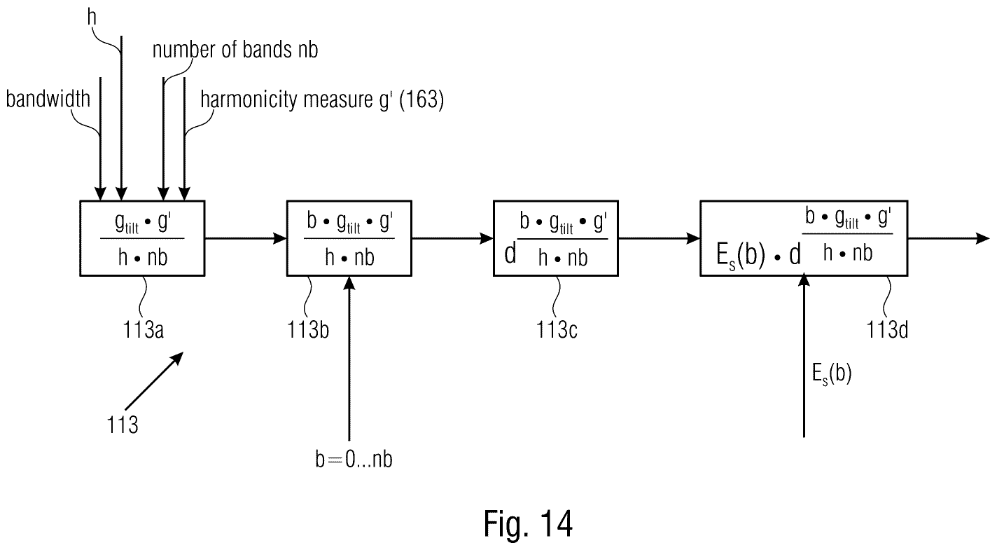

An example of how to perform the pre-emphasis (e.g. at 113) is shown in FIG. 14. At step 113a there is the multiplication of the harmonicity value 163 by the tilt factor gₜᵢₗₜ, and the division by the optional constant h and the constant nb. This may be performed only once per frame. At step 113b there is the multiplication by the band b (this may be repeated for each band b), to thereby obtain the tilt value. At step 113c there is the elevation of d>1 by the tilt value (exponent), to obtain the pre-emphasis factor. At step 113f the pre-emphasis factor scales the (smoothed) energy per band Eₛ(b). It is noted that steps 113c and 113d are also defined for each band.

### Codec Structure

The codec IVA is built upon the MDCT-based TCX from EVS [8, 9] with adaptations of some technologies from LC3 [5,6]. It has been proven in EVS and LC3 that an MDCT-based codec with HPF can code well a wide range of mono signals, including clean speech, at bitrates of 48 kbps and bandwidth of at least 16 kHz [5,6,8,9]. This codec structure can be extended by adding new or modifying existing technologies, so that coding of a wide range of signals may be possible even at lower bitrates.

### Codec Structure Overview

Some examples and further aspects are proposed here below.

The MDCT-based codec processes its input signal in frames of e.g. 20 ms, the length in samples being. The other components follow the same framing and have the update rate of 50 frames per second of the coded parameters.

The input signal x₁ (160), which is the original audio signal e.g. processed with a 20 Hz high-pass/DC rejection filter, is input to the pitch analysis and to the pulse extraction. In the pitch analysis, denoted as “Get pitch contour”, a pitch contour is obtained. The pitch contour steers many parts of the codec, including pulse extraction and HPF. The pitch contour tracks pitch change over time. Pitch is here used to term the fundamental frequency or the pitch lag, where the pitch lag is also known as the fundamental period and is the inverse of the fundamental frequency. Viewing pitch as a frequency or as a period is equivalent when describing the concepts of the implemented algorithms. When pitch is used for filtering in TD it is the corresponding pitch lag, expressed in number of samples, that is used. Whenever the exact representation is important, pitch will be denoted as pitch lag or fundamental frequency or frequency bin index.

The pulse extraction extracts pulses from x₁ and codes them, where a pulse may be a glottal pulse or any other kind of transient. The extracted pulses x_{P}_{₀} are subtracted from x₁. The signal without the pulses x_{M} is coded within an MDCT-based codec.

The decoded output xo of the MDCT-based codec is filtered via an HPF. The HPF produces xii, in which noise between harmonics is suppressed.

A waveform x_{P}_{₀} constructed from the coded pulses is added to xₕ to obtain the final output of the codec x₀.

### Encoder

The encoder (e.g. FIG. 13, which may be an instantiation of FIG. 1a or 1b or 1c or 1d or 1e or 1f) splits the input signal x₁ into e,g, 20 ms frames and outputs to the bit-stream 170 with the rate of e.g. 50 frames per second at least one or more of:
static configuration, 5 bits consisting of the bitrate and the bandwidth
pitch contour
MDCT window choice, e.g. 2 bits
LTP activation parameter
coded pulses
coded information for the spectral shaping via SNS, denoted as “sns”
coded information for the temporal shaping via TNS, denoted as “tns”
global gain g_{Q} that is the global quantization step size for the MDCT codec
the entropy coded quantized MDCT spectrum, denoted as “spect”
the parametrically coded zero portions of the quantized MDCT spectrum, denoted as “zfl”

The pitch contour is obtained and coded for frames with high harmonicity. For frames with low harmonicity, it is signaled with one bit that the pitch contour is not present. The pitch analysis also outputs the high frequency tonality flag ϕ_{H} and a flag indicating if constant parameters should be used for the HPF across the whole frame.

The pulse extraction obtains a short-time Fourier transform (STFT) of the input audio signal, and uses a non-linear magnitude spectrogram and the phase spectrogram of the STFT to find and extract pulses. Each pulse has a waveform with high-pass characteristics and the energy concentrated in the temporal center. The pulse residual signal x_{M} is obtained by subtracting a signal consisting of pulses x_{P}_{_{O}} from the input audio signal x_{I}. The pulses are coded and output by the “Pulse coding”.

The pulse residual signal x_{M} is windowed and transformed via the MDCT to produce the spectrum X_{M}. A spectrum consists of frequency coefficients, also named frequency bins or lines. The length of X_{M}, and all other spectra derived from X_{M}, is equal to the frame length H_{M}. The MDCT window is chosen among three windows as in EVS, with the difference that all three windows are symmetrical low overlap windows and that the overlap is longer. The low overlap window is equal to the square root of the Tukey window. The three windows used have the length of 30 ms, 25 ms and 21.25 ms with the corresponding overlap region having the length of 10 ms, 5 ms and 1.25 ms. The longer window allows better energy compaction for tonal signals compared to EVS. The decision which window to use is basically the same as in EVS, with the difference that there is only overlap change and no splitting of the frame into sub-frames. This means that the overlap choice is made so that an increase of energy occurs in the non-overlapping part of the MDCT window, thus avoiding problems with the MDCT unfolding and TNS. In the initial versions of IVA, sub-frames of 5 ms and 10 ms, as in EVS, were used. With the introduction of the pulse extraction and by using TNS, the need for splitting the frame is reduced. Avoiding the sub-frame splitting, makes the implementation of new technologies and the maintenance easier. It could be investigated in the future, if there are signals where the sub-frame splitting could be beneficial.

The spectral envelope of X_{M} is perceptually flattened using SNS obtaining X̅_{M}. SNS originates from LC3 [5,6]. It is implemented in IVA from scratch, with some algorithm adaptations compared to LC3.

TNS provides temporal shaping of the quantization noise by filtering across frequencies in the MDCT spectrum [7]. TNS filter coefficients are obtained from the autocorrelation of the MDCT spectrum and TNS is activated if the filter provides coding gain above a threshold. Two independent filters are used, one for the range from 800 to 4500 Hz and another one above 4500 Hz. If it is active, the TNS filters X̅_{M} and produces X̅_{M} as its output. The TNS implementation is essentially the same as in EVS, the main difference being additional tuning of the frequency range where it is used and the activation thresholds. TNS and the pulse coding complement each other. Since the TNS filters are of relatively low order, they cannot model very sharp changes in the time envelope of the signal. As the pulse coding only models transients of short duration, TNS is still needed for modeling temporally broader transients and strong onsets of a noise or a tone.

The perceptually flattened predicted MDCT spectrum X_{F}_{₀}, obtained from the previously decoded frames via LTP, is subtracted from X̅_{M} and the resulting difference \dot{X}_{M} is quantized and coded in the integral band-wise parametric coder (iBPC). A part of the decoder, required for the functionality of LTP, must also be included in the encoder, but is not shown in FIG. 13 to keep it readable. The quantization process finds the optimal global gain g_{Q} and outputs besides the quantized global gain also the entropy coded quantized MDCT spectrum “spect” and energy levels “zfl” in bands quantized to zero. The iBPC uses an arithmetic coder for coding both “spect” and “zfl”. The probability and context tables from EVS are kept [8,9], while the arithmetic coder is implemented as in LC3 [5]. A pair of values, called 2-tuple, is jointly coded as in EVS and LC3. The arithmetic coder from LC3 has smaller computational complexity than the one from EVS. It also has exact bit demand estimation using just table lookup.

Therefore, as explain above, the spectral representation (e.g. as outputted by the converter 100, is divided into two parts, and the first part 100′ (e.g. obtained from MDCT coefficients) may be partially sent to the spectral processor 120 to obtain the encoded version of the spectral representation, while a second part 100″ (e.g. obtained from the MDST representation) is not used, but both the first part 100′ and the second part 100″ may be provided to the scale parameter calculator 110 to obtain the scale factors (or processed version thereof).

### Pitch Contour

The pitch contour is determined by \dot{d}_{F}_{₀}, \acute{d}_{F}_{₀} and \grave{d}_{F}_{₀}. The pitch \dot{d}_{F}_{₀} is found in the middle and the pitch \acute{d}_{F}_{₀} at the end of the current MDCT window. The pitch \grave{d}_{F}_{₀}, at the start of the current window, is equal to \acute{d}_{F}_{₀} from the previous frame. The intervals where these and other pitch values are found is presented relative to the MDCT windowing and input signal framing.

The pitch values estimated by the pitch search fall between the minimum pitch lag ď_{F}_{₀}=2.25 ms (corresponding to 444.4 Hz) and the maximum pitch lag \hat{d}_{F}_{₀}=19.5 ms (corresponding to 51.3 Hz). The range from ď_{F}_{₀} to \hat{d}_{F}_{₀} will be referred to as “the full pitch range”.

The values of \dot{d}_{F}_{₀} and \acute{d}_{F}_{₀} are found in multiple steps. In each step, a pitch search is executed on one of the intervals. To reduce complexity, a pitch is first searched in the input signal downsampled to 8 kHz, followed by a search in the original input signal at the full input sampling rate around the value obtained on the downsampled signal.

The core of the process is the pitch search [symbol] _{F}_{₀}, executed in each of the multiple steps. The pitch search [symbol] _{F}_{₀} is also used in the HPF.

### Pitch Search

The pitch search [symbol] _{F}_{₀} calculates normalized autocorrelation of its input x and its delayed version in the range from d_{\check{F}}_{₀} to d_{\hat{F}}_{₀}:

$$\\ {ρ}_{H} [ m ] = \frac{{\sum }_{n = 0}^{{L}_{H}} x [ n ] x [ n - m ]}{\sqrt{( {\sum }_{n = 0}^{{L}_{H}} {x}^{{}_{} 2} [ n ] ) ( {\sum }_{n = 0}^{{L}_{H}} {x}^{{}_{} 2} [ n - m ] )}} , {d}_{{\check{F}}_{0}} \leq m \leq {d}_{{\hat{F}}_{0}}$$

Fractional delays are obtained by interpolating ρ_{H}. The interpolation is done using filters from a predefined list of filters, each filter having a distinct fractional delay between 0 and 1. It will be further considered that ρ_{H} [m] also includes values for fractional delays m, that is, ρ_{H} [m] is also defined when m is a rational number. Besides d_{\check{F}}_{₀}, d_{\hat{F}}_{₀} and L_{H}, an initial pitch candidate d_{\tilde{F}}_{₀} is also a parameter of [symbol] _{F}_{₀}. [symbol] _{F}_{₀} returns an optimal pitch d_{\ddot{F}}_{₀} and an associated harmonicity level ρ_{\ddot{F}}_{₀}:

$$\\ ( {d}_{{\ddot{F}}_{0}} , {ρ}_{{\ddot{F}}_{0}} ) = {{F}_{0}}_{} ( x , {d}_{{\check{F}}_{0}} , {d}_{{\hat{F}}_{0}} , {L}_{H} , {d}_{{\tilde{F}}_{0}} )$$

The value of the initial pitch candidate d_{\tilde{F}}_{₀} is, in most cases, a value of d_{\ddot{F}}_{₀} returned by a previous call to [symbol] _{F}_{₀} for a temporally preceding interval or for a downsampled version of x.

The harmonicity level ρ_{\ddot{F}}_{₀} is obtained from the normalized autocorrelation ρ_{H} depending on d_{\ddot{F}}_{₀}. The value of ρ_{\ddot{F}}_{₀} is between zero and one, zero meaning no harmonicity and one the maximum harmonicity.

The location of the absolute maximum in ρ_{H} is the first candidate d_{F}_{₁} for d_{\ddot{F}}_{₀}:

$$\\ {d}_{{F}_{1}} = {arg max}_{{d}_{{\check{F}}_{0}} \leq m \leq {d}_{{\hat{F}}_{0}}} {ρ}_{H} [ m ]$$

The second candidate d_{F}_{₂} is the local maximum of ρ_{H} near d_{\tilde{F}}_{₀}. If d_{\tilde{F}}_{₀} is near d_{F}_{₁} the local maximum would probably coincide with d_{F}_{₁} and thus, instead of searching for a local maximum, d_{F}_{₂} is simply set to d_{\tilde{F}}_{₀}.

The value of d_{\ddot{F}}_{₀} is chosen among d_{F}_{₁} and d_{F}_{₂}, with a preference for d_{F}_{₂}:

$$\\ {d}_{{\ddot{F}}_{0}} = \{ \begin{matrix}{d}_{{F}_{1}} , {ρ}_{H} [ {d}_{{F}_{1}} ] - {ρ}_{H} [ {d}_{{F}_{2}} ] \geq {τ}_{{F}_{0}} \\ {d}_{{F}_{2}} , {ρ}_{H} [ {d}_{{F}_{1}} ] - {ρ}_{H} [ {d}_{{F}_{2}} ] < {τ}_{{F}_{0}}\end{matrix}$$

$$\\ {τ}_{{F}_{0}} = \{ \begin{matrix}0.01 , 0.75 {d}_{{F}_{1}} \leq {d}_{{\tilde{F}}_{0}} \leq 1.25 {d}_{{F}_{1}} \\ 0.02 , {d}_{{F}_{1}} \leq {d}_{{F}_{2}} \\ 0.03 , {d}_{{F}_{1}} > {d}_{{F}_{2}}\end{matrix}$$

The values of τ_{F}_{₀} were found heuristically. The threshold is bigger if there is a possibility of an octave jump, which would occur if d_{\tilde{F}}_{₀} was returned by [symbol] _{F}_{₀} in the temporally preceding interval and d_{\tilde{F}}_{₀} is an integer multiple of d_{\ddot{F}}_{₀} or d_{\ddot{F}}_{₀} is an integer multiple of d_{\tilde{F}}_{₀}. Preferring d_{F}_{₂} avoids possible octave jumps and to some extent increases pitch detection accuracy in presence of noise.

### Obtaining the Pitch Contour

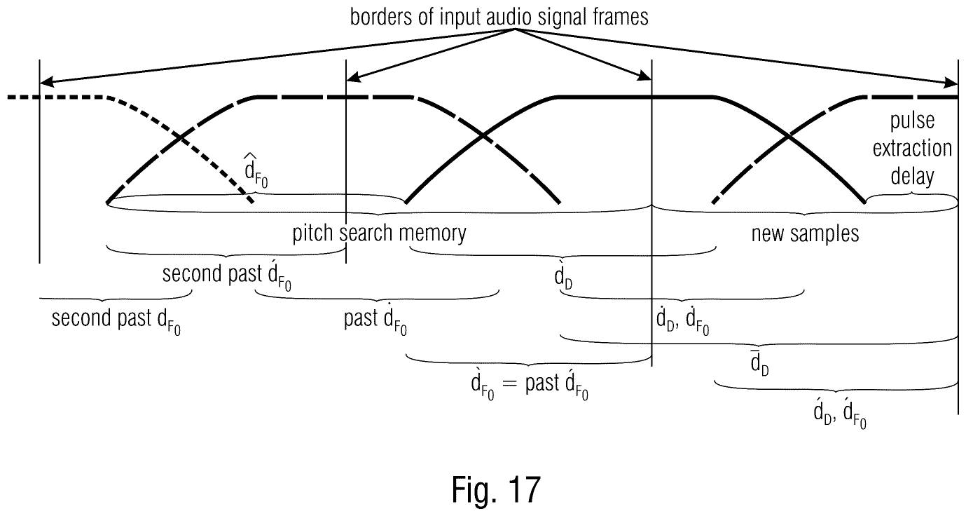

In each of the intervals depicted in FIG. 17, L_{H} in the call to [symbol] _{F}_{₀} is set to the length of the interval and x[0] is the first sample in the interval.

The values of \grave{d}_{D}, d̅_{D}, \dot{d}_{D} and \acute{d}_{D} are obtained at the downsampled signal.

First, the pitch \grave{d}_{D} and the associated \grave{ρ}_{D} are obtained via [symbol] _{F}_{₀} using the full pitch range and d_{\tilde{F}}_{₀}=\grave{d}_{F}_{₀}. Then d̅_{D} and ρ̅_{D} are obtained using again the full pitch range and d_{\tilde{F}}_{₀}=\grave{d}_{D}. \dot{d}_{D} and \acute{d}_{D} are found setting d_{\tilde{F}}_{₀}=d̅_{D}, d_{\check{F}}_{₀}=0.3d̅_{D} and d_{\hat{F}}_{₀}=0.7d̅_{D}.

The value of \dot{d}_{F}_{₀} and \acute{d}_{F}_{₀} and the associated harmonicities \dot{ρ}_{F}_{₀} and \acute{ρ}_{F}_{₀} are obtained via [symbol] _{F}_{₀} from tie input signal at the input sampling rate, setting d_{\tilde{F}}_{₀}=d_{D}, d_{\check{F}}_{₀}=d_{D}−a and d_{\hat{F}}_{₀}=d_{D}+a, where a is the ratio of the input sampling rate and the downsample rate 8 kHz (e.g. a=6 for the input sampling rate of 48 kHz). d_{D}=\dot{d}_{D} for finding \dot{d}_{F}_{₀} and d_{D}=\acute{d}_{D} for \acute{d}_{F}_{₀}.

The frame is considered to have high harmonicity if max(\grave{ρ}_{D},ρ̅_{D})≥0.3 and \acute{ρ}_{F}_{₀}≥0.3 and \dot{ρ}_{F}_{₀}≥0.6. Otherwise the frame is of low harmonicity and the pitch contour is not coded.

For frames with high harmonicity, \acute{d}_{F}_{₀} is absolutely coded and \dot{d}_{F}_{₀} is differentially coded. \dot{d}_{F}_{₀} is coded differentially to (\grave{d}_{F}_{₀}+\grave{d}_{F}_{₀})/2 using 3 bits. A predefined difference value is associated with each of the 8 codes for the differential coding of \dot{d}_{F}_{₀}. The code for the difference, that minimizes the autocorrelation in the interval associated with \dot{d}_{F}_{₀}, is chosen for \dot{d}_{F}_{₀}.

If \acute{ρ}_{F}_{₀}<\dot{ρ}_{F}_{₀}/2, it is considered that there is an end of the harmonicity in the frame. For such frames, \acute{d}_{F}_{₀} is set to 2\dot{d}_{F}_{₀}−\grave{d}_{F}_{₀} before coding it. This allows differential coding of \dot{d}_{F}_{₀} even when there is no harmonicity at the end of the frame and the originally found \acute{d}_{F}_{₀} is unreliable.

The pitch contour d_{V} is obtained by an interpolation of the decoded values of \dot{d}_{F}_{₀} and \acute{d}_{F}_{₀}. The pitch contour d_{V} provides a value at every sample in the current MDCT window and at least in the past \hat{d}_{F}_{₀} samples. We denote the pitch at sample i as d_{V}[i]. The pitch contour in the samples before the current window is needed for LTP.

FIG. 17 shows a schematic presentation of the interpolation for the pitch contour The pitch contour consists of the constant and interpolated parts, as depicted in FIG. 17, where the usage location of each coded pitch value is indicated in relation to the MDCT window, the input and output frame borders.

If

$$\\ \vert {{d}^{′}}_{{F}_{0}} - {\dot{d}}_{{F}_{0}} \vert \leq \frac{1}{24} ms , \vert {{ρ}^{′}}_{{F}_{0}} - {\dot{ρ}}_{{F}_{0}} \vert \leq 0.5$$

and there is no significant amplitude modulation in the interval where \acute{d}_{F}_{₀} and \dot{d}_{F}_{₀} was found, it is indicated that the HPF should use constant parameters across the whole frame.

The average pitch lag d̅_{F}_{₀} is calculated for each frame as the arithmetic mean of \acute{d}_{F}_{₀}, \dot{d}_{F}_{₀} and \grave{d}_{F}_{₀}. If any of \acute{d}_{F}_{₀}, \dot{d}_{F}_{₀}, \grave{d}_{F}_{₀} is zero then d̅_{F}_{₀} is also set to zero, which happens when there is no harmonicity in the current or the previous frame.

### Additional Tonality Measure

### Per MDCT Bin Tonality

It is determined for each MDCT frequency bin between 4.8 kHz and 16 kHz, as in 5.3.3.2.5 in the EVS algorithmic description [8], if the frequency bin belongs to a tone or contains mostly noise. The bin tonality is used, as in EVS, for the adaptive changing of the dead-zone in the MDCT spectrum quantizer.

### High Frequency Tonality Flag

The total number of tonal frequency bins \dot{N}_{T} is calculated in the current frame and smoothed over time: N_{T}=0.5N_{T}+\dot{N}_{T}.

Normalized correlation ρ_{H}_{_{F}} is calculated on a high-pass filtered x_{M} between the samples in the current MDCT window and the samples at the d̅_{F}_{₀} delay, where x_{M} is filtered using a symmetric 5 tap finite impulse response (FIR) filter with the −3 dB cutoff at 6 kHz.

The high frequency tonality flag ϕ_{H} is set to 1 if TNS is inactive, the pitch contour is present and there is a tonality in high frequencies, where the tonality exists in high frequencies if ρ_{H}_{_{F}}>0.7 or N_{T}>1.

The high frequency tonality flag ϕ_{H} is used in the decoder to decide how to fill MDCT coefficients quantized to zero.

### SNS

The SNS scale factors are obtained from smoothed and spectrally tilted energies in e.g. N_{B} (e.g. 64, or a different number) frequency bands having increasing widths. The band energies (or more in general amplitude-related measures) are optionally transformed to a logarithmic domain (e.g. 115, step 5) after optionally adding a noise floor (e.g. 114, step 4). The band energies (or more in general amplitude-related measures) are then e.g. downsampled (e.g. by the downsampler 130) to 16 values in the logarithmic domain, the arithmetic mean e.g. is removed and a fixed scaling is applied. The 16 values are then quantized and coded, the coded values being denoted as “sns”. The 16 quantized values are e.g. interpolated and transformed back to the linear domain. The interpolated scale factors are applied on the MDCT spectrum, where in SNS_{E} the MDCT spectrum is divided by the scale factors and in SNS_{D} multiplied. This process is the same as in LC3 [5, 6].

Different to the SNS implementation in LC3 is that the N_{B} (e.g. 64, or a different number) band energies are obtained from a squared magnitude spectrum. Using the magnitude instead of the MDCT avoids the problem of the MDCT temporal variation for constant amplitude signals.

Another difference is that the band energies are not normalized by the band width. (see step 1 above, where it is explained that

$$\\ {E}_{B} ( b ) = {\sum }_{k = Ind ( b )}^{Ind ( b + 1 ) - 1} \frac{{X ( k )}^{2}}{Ind ( b + 1 ) - Ind ( b )}$$

may be substituted by E_{B}(b)=Σ_{k=Ind(b)}^{Ind(b+1)-1}X(k)², and

$$\\ {E}_{B} ( b ) = {\sum }_{k = Ind ( b )}^{Ind ( b + 1 ) - 1} \frac{{X ( k )}^{2} + {Y ( k )}^{2}}{Ind ( b + 1 ) - Ind ( b )}$$

may be substituted by E_{B}(b)=Σ_{k=Ind(b)}^{Ind(b+1)-1}[X(k)²+Y(k)²]. By not normalizing the band energies, a similar effect is obtained as by the fixed spectral tilt in LC3 SNS. This difference is advantageous because it reduces computational complexity by avoiding the divisions used in the normalization of the band energies. Instead of LC3's strong fixed spectral tilt, smaller adaptive tilt is used, proportional to the harmonicity of the input signal. Via the stronger tilt for harmonic signals, harmonic components at low frequencies are given more importance and vice versa. Weaker tilt for applause signals achieves more even distribution of quantization steps across the whole bandwidth and allows perceptually efficient coding of wideband transients.

An additional difference is that, in some examples, the SNS scale factors are coded using a two stage full search vector quantizer without a split, having 9 bits in the first and 6 bits in the second stage. This quantization scheme requires less bits than the scheme with pyramid vector quantizer in LC3, thus leaving more bits for coding the flattened MDCT spectrum, which was shown to be beneficial.

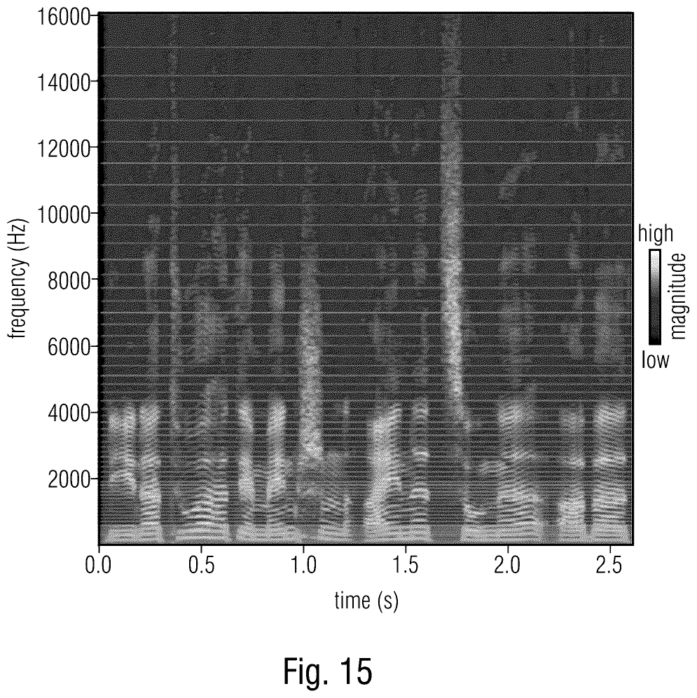

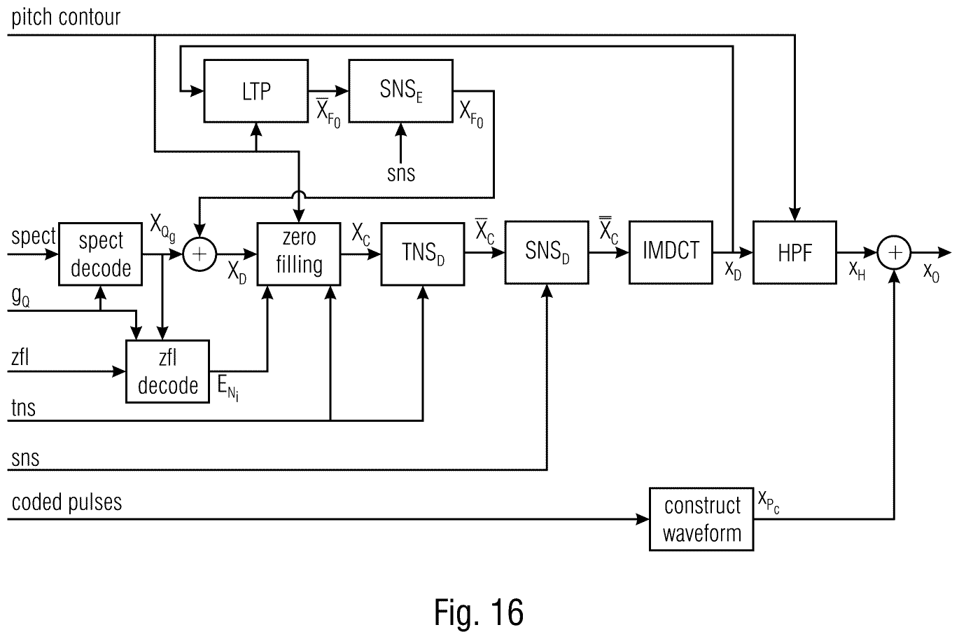

The borders of the N_{B} (e.g. 64, or a different number) bands used in IVA are shown as horizontal lines in FIG. 15. The last band from 16 to 24 kHz is not shown.

The quantized values are interpolated to 128 scale factors, thus producing a smoother envelope than the N_{B} (e.g. 64, or a different number) interpolated scale factors in LC3. The 128 bands are obtained by splitting each of the 64 bands into two halves.

### Decoder

Some discussion on the decoder is here provided.

The decoder (e.g. 800) processes the output of the encoder frame by frame.

The coded “spect” is decoded to obtain the quantized MDCT spectrum X_{Q}. The energies E_{N}_{ᵢ} are decoded from “zfl” for sub-bands that are completely zero in X_{Q}. The quantized MDCT spectrum X_{Q} is scaled with the global gain g_{Q} to produce X_{Q}_{_{g}}. Since the zeros in X_{Q} and in X_{Q}_{_{g}} are at the same position, each of them can be used for determining the location of the zeros.

The perceptually flattened predicted MDCT spectrum X_{F}_{₀}, obtained from the previously decoded frames via LTP, is added to X_{Q}_{_{g}}, producing X_{D}. For spectral coefficients that are zero in X_{Q}_{_{g}}, values are generated in the Zero Filling and added to X_{D}, producing X_{C}. The Zero Filling is generated depending on the high frequency tonality ϕ_{H} flag, “pitch contour”, “tns”, E_{N}_{ᵢ} and the content of X_{D}. The Zero Filling includes copying from the low frequency regions into the high frequency regions, known as the copy-up.

If TNS is active, the temporal envelope is restored in “TNS_{D}” producing X̅_{C}. Further the spectral envelope is restored in “SNS_{D}” to produce X̅_{C}. By restoring the temporal and spectral envelopes, the quantization noise is shaped accordingly. Since it is expected that the quantization noise is uniformly distributed and since SNS is perceptually motivated, the quantization noise in X̅_{C} should be perceptually minimized for the given bitrate constraint. As discussed in previous chapter, the uniform distribution of the quantization noise cannot be truly satisfied at low bitrates, but we assume that it is at least somewhat achieved. To truly minimize the perceived distortions of the decoded output, all components need to be tuned in an iterative process to account for their interaction. This is a disadvantage over the analysis by synthesis approach, but allows developing a low computational complexity system that doesn't rely on a psychoacoustic model which should be tuned also in accordance to the system.

The reshaped spectrum X̅_{C} is a quantized version of the original spectrum X_{M}. It is converted to the time domain signal x_{D} via the inverse MDCT, windowing and adding of the overlapping parts, thus also achieving TDAC. The joint process of the inverse MDCT, windowing and the adding of the overlapping parts is presented in diagrams using single block named “IMDCT”.

LTP generates a time domain prediction from x_{D} depending on the pitch contour and the LTP activation parameter, windows the time domain prediction and converts the windowed signal to the predicted MDCT spectrum X̅_{F}_{₀}. The spectrum X̅_{F}_{₀} is perceptually flattened using the “SNS_{E}”. The perceptually flattened predicted MDCT spectrum X_{F}_{₀} is in the same domain as \dot{X}_{M} and X_{Q}_{_{g}} and can be used to reduce the range of values in the spectrum to be coded.

As already mentioned, x_{H} is produced by suppressing noise between harmonics of x_{D} via HPF, driven by the pitch contour. Finally x_{P}_{_{C}}, constructed from the coded pulses, is added to x_{H} to obtain the final output of the codec x_{O}.

### Final Aspects

An inventively encoded audio signal can be stored on a digital storage medium or a non-transitory storage medium or can be transmitted on a transmission medium such as a wireless transmission medium or a wired transmission medium such as the Internet.

Although some aspects have been described in the context of an apparatus, it is clear that these aspects also represent a description of the corresponding method, where a block or device corresponds to a method step or a feature of a method step. Analogously, aspects described in the context of a method step also represent a description of a corresponding block or item or feature of a corresponding apparatus.

Depending on certain implementation requirements, embodiments of the invention can be implemented in hardware or in software. The implementation can be performed using a digital storage medium, for example a floppy disk, a DVD, a CD, a ROM, a PROM, an EPROM, an EEPROM or a FLASH memory, having electronically readable control signals stored thereon, which cooperate (or are capable of cooperating) with a programmable computer system such that the respective method is performed.

Some embodiments according to the invention comprise a data carrier having electronically readable control signals, which are capable of cooperating with a programmable computer system, such that one of the methods described herein is performed.

Generally, embodiments of the present invention can be implemented as a computer program product with a program code, the program code being operative for performing one of the methods when the computer program product runs on a computer. The program code may for example be stored on a machine readable carrier.

Other embodiments comprise the computer program for performing one of the methods described herein, stored on a machine readable carrier or a non-transitory storage medium.

In other words, an embodiment of the inventive method is, therefore, a computer program having a program code for performing one of the methods described herein, when the computer program runs on a computer. A further embodiment of the inventive methods is, therefore, a data carrier (or a digital storage medium, or a computer-readable medium) comprising, recorded thereon, the computer program for performing one of the methods described herein.

A further embodiment of the inventive method is, therefore, a data stream or a sequence of signals representing the computer program for performing one of the methods described herein. The data stream or the sequence of signals may for example be configured to be transferred via a data communication connection, for example via the Internet.

A further embodiment comprises a processing means, for example a computer, or a programmable logic device, configured to or adapted to perform one of the methods described herein.

A further embodiment comprises a computer having installed thereon the computer program for performing one of the methods described herein.

In some embodiments, a programmable logic device (for example a field programmable gate array) may be used to perform some or all of the functionalities of the methods described herein. In some embodiments, a field programmable gate array may cooperate with a microprocessor in order to perform one of the methods described herein. Generally, the methods are preferably performed by any hardware apparatus.

The above described embodiments are merely illustrative for the principles of the present invention. It is understood that modifications and variations of the arrangements and the details described herein will be apparent to others skilled in the art. It is the intent, therefore, to be limited only by the scope of the impending patent claims and not by the specific details presented by way of description and explanation of the embodiments herein.

### BIBLIOGRAPHY

[1] ISO/IEC 14496-3:2001; Information technology—Coding of audio-visual objects—Part 3: Audio.
[2] 3GPP TS 26.403; General audio codec audio processing functions; Enhanced aacPlus general audio codec; Encoder specification; Advanced Audio Coding (AAC) part.
[3] ISO/IEC 23003-3; Information technology—MPEG audio technologies—Part 3: Unified speech and audio coding.
[4] 3GPP TS 26.445; Codec for Enhanced Voice Services (EVS); Detailed algorithmic description.

LC3 is referred in:
[5] “Low Complexity Communication Codec,” Bluetooth Specification v1.0, 2020.
[6] “Digital Enhanced Cordless Telecommunications (DECT); Low Complexity Communication Codec plus (LC3plus),” ETSI TS 103 634 v1.1.1, 2019.
[7] J. Herre and J. D. Johnston, “Enhancing the Performance of Perceptual Audio Coders by Using Temporal Noise Shaping (TNS),” 101st AES Convention, Los Angeles, 1996.
[8] “3rd Generation Partnership Project; Technical Specification Group Services and System Aspects; Codec for Enhanced Voice Services (EVS); Detailed algorithmic description,” 3GPP TS 26.445 v16, 2019.
[9] Codec for Enhanced Voice Services (EVS); ANSI C code (floating-point), 3GPP TS 26.443 v13.1, https://www.3gpp.org/DynaReport/26443.htm

1. An apparatus for encoding an audio signal, comprising:
a converter for converting the audio signal into a spectral representation;
a scale parameter calculator for calculating a set of scale parameters based on the audio signal;
a spectral processor for processing the spectral representation, or at least part thereof, using the set of scale parameters, or a modified version thereof;
a scale parameter encoder for generating an encoded representation of the scale parameters, or of the modified version of the scale parameters, wherein the scale parameter calculator is configured to calculate an amplitude-related measure for each band to obtain a set of amplitude-related measures, the scale parameter calculator being configured to perform a pre-emphasis operation to the set of amplitude-related measures, so that low frequency amplitudes are emphasized with respect to high frequency amplitudes according to a tilt value, or according to a pre-emphasis factor, wherein the scale parameter calculator is configured to control the tilt value, or to control the pre-emphasis factor, based on a harmonicity measure of the audio signal, to thereby obtain the set of scale parameters; and
an output interface to generate an encoded audio signal comprising information on an encoded representation of the spectral representation, or the at least part thereof, and information on the encoded representation of the scale parameters or of the modified version of the scale parameters.

2. The apparatus of claim 1, configured to obtain the harmonicity measure of the audio signal using an autocorrelation measurement of the audio signal.

3. The apparatus of claim 1, configured to obtain the harmonicity measure of the audio signal using a normalized autocorrelation measurement of the audio signal.

4. The apparatus of claim 1, wherein the harmonicity measure of the audio signal is a value between 0 and a value different from zero, so that a lower harmonicity is closer to 0 than a higher harmonicity.

5. The apparatus of claim 1, wherein the scale parameter calculator is configured so that a comparatively higher value of the harmonicity measure of the audio signal causes a higher tilt value, or a higher pre-emphasis factor, than a comparatively lower value of the harmonicity measure.

6. The apparatus of claim 1, wherein the scale parameter calculator is configured to process the amplitude-related measures:
$$\\ {E}_{p} ( b ) = {E}_{s} ( b ) \cdot {d}^{{}_{} ( \frac{b \cdot {g}_{{}_{} tilt} \cdot {g}^{{}_{} ′}}{{}^{} h \cdot nb} )} , where \frac{b \cdot {g}_{tilt} \cdot {g}^{{}_{} ′}}{h \cdot nb}$$
is the tilt value, which is an exponent applied to d, where h is fixed, g′≥0 is, or is derived from, the harmonicity measure, gₜᵢₗₜ is pre-defined, b is an index indicating the band out of nb+1 bands in such a way that a higher frequency band has a higher index than a lower frequency band, Eₛ(b) is the set of amplitude-related measures and Eₚ(b) is a pre-emphasized energy per band.

7. The apparatus of claim 1, wherein the scale parameter calculator is configured to process the amplitude-related measures by applying the tilt value to be proportional with at least the harmonicity measure, or the pre-emphasis factor to be obtained by raising a constant number with an exponent proportional with at least the harmonicity measure.

8. The apparatus of claim 1, wherein the scale parameter calculator is configured to process the amplitude-related measures by applying the tilt value to be proportional with at least an index which increases with higher bands, or the pre-emphasis factor obtained by raising a constant number with an exponent proportional with at least an index which increases with higher bands.

9. The apparatus of claim 1, wherein the scale parameter calculator is configured to process the amplitude-related measures by applying the tilt value, or the pre-emphasis factor, to be dependent on the bandwidth of the spectral representation.

10. The apparatus of claim 1, wherein the scale parameter calculator is configured to process the amplitude-related measures by applying the tilt value to be linear with the harmonicity measure, or pre-emphasis factor to be obtained by raising a constant number with an exponent which is linear with the harmonicity measure.

11. The apparatus of claim 1, wherein the scale parameter calculator is configured to obtain the amplitude-related measures from a squared magnitude spectrum of the audio signal.

12. The apparatus of claim 11, wherein each amplitude-related measure is obtained as an integral, or a sum, of squared magnitude values of a spectrum of the audio signal.

13. The apparatus of claim 12, wherein the integral, or sum, of the squared magnitude values of the spectrum of the audio signal is not normalized using the width of each band.

14. The apparatus of claim 12, wherein the integral, or sum, of the squared magnitude values of the spectrum of the audio signal is obtained, for each index, by a sum of a squared modified discrete cosine transform, MDCT, coefficient and a squared modified discrete cosine transform, MDST, coefficient.

15. The apparatus of claim 1, wherein the converter (100) is configured to perform an MDCT transformation and an MDST transformation, to provide MDCT coefficients and MDST coefficients, wherein the amplitude-related measure for each band is obtained as sum of magnitudes of the MDCT coefficients, or a squared version(s) thereof, and magnitudes of the MDST coefficients, or a squared version(s) thereof.

16. The apparatus of claim 1, wherein the scale parameter calculator is configured to control the tilt value or the pre-emphasis factor based on a long term predictor, LTP, parameter or on a long term post-filter LTPF parameter as the harmonicity measure of the audio signal.

17. The apparatus of claim 1, wherein the scale parameter calculator is configured to control the tilt value or the pre-emphasis factor based on a spectral flatness measure as the harmonicity measure of the audio signal.

18. The apparatus of claim 1, configured to quantize the harmonicity measure of the audio signal, so as to control the tilt value or the pre-emphasis factor based on a quantized version of the harmonicity measure of the audio signal.

19. The apparatus of claim 1, further comprising a downsampler to downsample the set of scale parameters, which is a first set of scale parameters, to obtain a second set of scale parameters, which is, or is comprised in, the modified version of the first set of scale parameters, the second set of scale parameters having a second number of scale parameters which is lower than a first number of scale parameters of the first set of scale parameters, wherein the scale parameter encoder is configured to generate the encoded representation of the second set of scale parameters as the encoded representation of the modified version of the scale parameters.

20. The apparatus of claim 1, further comprising a downsampler to downsample the set of scale parameters, which is a first set of scale parameters, to obtain a second set of scale parameters, the second set of scale parameters having a second number of scale parameters which is lower than a first number of scale parameters of the first set of scale parameters,
wherein the spectral processor is configured to process the spectral representation, or the at least part thereof, using a third set of scale parameters, which is, or is comprised in, the modified version of scale parameters.

21. The apparatus of claim 20,
wherein the spectral processor is configured to determine this third set of scale parameters so that the third number is equal to the first number.

22. The apparatus of claim 19,
wherein the scale parameter calculator is configured to
calculate, for each band of a plurality of bands of the spectral representation, the amplitude-related measures in a linear domain to obtain a first set of linear domain measures;
to transform the first set of linear-domain measures into a log-like domain to obtain the first set of log-like domain measures; and
wherein the downsampler is configured to downsample the first set of scale factors in the log-like domain to obtain the second set of scale factors in the log-like domain.

23. The apparatus of claim 19,
wherein the scale parameter calculator is configured to calculate the first set of scale parameters for non-uniform bands, and
wherein the downsampler is configured to downsample the first set of scale parameters to obtain a first scale factor of the second set by combining a first group having a first predefined number of frequency adjacent scale parameters of the first set, and wherein the downsampler is configured to downsample the first set of scale parameters to obtain a second scale parameter of the second set by combining a second group having a second predefined number of frequency adjacent scale parameters of the first set, wherein the second predefined number is equal to the first predefined number, and wherein the second group has members that are different from members of the first predefined group.

24. The apparatus of claim 19, wherein the downsampler is configured to use an average operation among a group of first scale parameters, the group having two or more members.

25. The apparatus of claim 19,
wherein the downsampler is configured to perform a mean value removal so that the second set of scale parameters is mean free.

26. The apparatus of claim 19,
wherein the downsampler is configured to perform a scaling operation using a scaling factor lower than 1.0 and greater than 0.0 in a log-like domain.

27. The apparatus of claim 19,
configured to provide a second set of quantized scale factors associated with the encoded representation, and
wherein the spectral processor is configured to derive the third set of scale factors from the second set of quantized scale factors.

28. The apparatus of claim 19,
configured to quantize and encode the second set using a vector quantizer, wherein the encoded representation comprises one or more indices for one or more vector quantizer codebooks.

29. The apparatus of claim 19,
wherein the spectral processor is configured to perform an interpolation operation in a log-like domain, and
to convert interpolated scale factors into a linear domain to obtain a third set of scale parameters.

30. The apparatus of claim 19,
wherein the scale parameter calculator is configured to calculate an amplitude-related measure for each band to obtain a set of amplitude-related measures, and
to smooth, the energy-related measures to obtain a set of smoothed amplitude-related measures as the set of scale factors.

31. The apparatus of claim 19,
wherein the spectral processor is configured to weight spectral values in the spectral representation using the set of scale factors, or modified version thereof, to obtain a weighted spectral representation and to apply a temporal noise shaping (TNS) operation onto the weighted spectral representation, and
wherein the spectral processor is configured to quantize and encode a result of the temporal noise shaping operation to obtain the encoded representation of the spectral representation.

32. The apparatus of claim 19,
wherein the converter uses an analysis window to generate a sequence of blocks of windowed audio samples, and a time-spectrum converter for converting the blocks of windowed audio samples into a sequence of spectral representations, a spectral representation being a spectral frame or a spectrum of the audio signal.

33. The apparatus of claim 19,
wherein the converter is configured to apply a modified discrete cosine transform, MDCT, operation to obtain an MDCT spectrum from a block of time domain samples, or
wherein the scale factor calculator is configured to calculate, for each band, an energy of the band, the calculation comprising squaring spectral lines, adding squared spectral lines, or
wherein the spectral processor is configured to scale spectral values of the spectral representation or to scale spectral values derived from the spectral representation in accordance with a band scheme, the band scheme being identical or different to the band scheme used in calculating the set of scale factors by the scale factor calculator, or
wherein the spectral processor is configured to calculate a global gain for all bands and to quantize the spectral values subsequent to a scaling depending on the scale factors using a scalar quantizer, wherein the spectral processor is configured to control a step size of the scalar quantizer dependent on the global gain.

34. The apparatus of claim 19, wherein the scale parameter calculator is configured to obtain the set of amplitude-related measures as a set of energies per bands.

35. The apparatus of claim 19, wherein the converter is configured to perform a first conversion to obtain a first part of the spectral representation and a second conversion to obtain a second part of the spectral representation, or wherein the converter is configured to perform a single conversion to obtain the spectral representation that has a first part of the spectral representation and a second part of the spectral representation, wherein the first part of the spectral representation is provided to the spectral processor, and the second part of the spectral representation is not processed by the spectral processor, and both the first part of the spectral representation and the second part of the spectral representation are provided to the scale parameter calculator to calculate the set of scale parameters based on both the first part of the spectral representation and the second part of the spectral representation.

36. The apparatus of claim 35, wherein the first part of the spectral representation is formed by MDCT coefficients and the second part of the spectral representation is formed by MDST coefficients, or the first part of the spectral representation is formed by MDST coefficients and the second part of the spectral representation is formed by MDCT coefficients.

37. The apparatus of claim 35, wherein the scale parameter calculator is configured to obtain the amplitude-related measures from the first part of the spectral representation, squared, summed to the second part of the spectral representation, squared.

38. The apparatus of claim 1, wherein the scale parameter calculator is configured to obtain the amplitude-related measures from the spectral representation, or at least part thereof.

39. A method for encoding an audio signal, comprising:
converting the audio signal into a spectral representation;
calculating a set of scale parameters based on the audio signal;
processing the spectral representation, or at least part thereof, using the set of scale parameters, or a modified version thereof;
generating an encoded representation of the scale parameters, or of the modified version of the scale parameters; wherein calculating includes calculating an amplitude-related measure for each band to obtain a set of amplitude-related measures, wherein calculating comprises performing a pre-emphasis operation to the set of amplitude-related measures, so that low frequency amplitudes are emphasized with respect to high frequency amplitudes according to a tilt value, or according to a pre-emphasis factor, wherein calculating comprises controlling the tilt value or controlling the pre-emphasis factor based on a harmonicity measure of the audio signal, to thereby obtain the set of scale parameters;
generating an encoded audio signal comprising information on an encoded representation of the spectral representation, or the at least part thereof, and information on the encoded representation of the scale parameters or of the modified version of the scale parameters.

40. A non-transitory storage unit storing instruction which, when executed by a processor, cause the processor to control or perform the following method:
converting the audio signal into a spectral representation;
calculating a set of scale parameters based on the audio signal;
processing the spectral representation, or at least part thereof, using the set of scale parameters, or a modified version thereof;
generating an encoded representation of the scale parameters, or of the modified version of the scale parameters; wherein calculating includes calculating an amplitude-related measure for each band to obtain a set of amplitude-related measures, wherein calculating comprises performing a pre-emphasis operation to the set of amplitude-related measures, so that low frequency amplitudes are emphasized with respect to high frequency amplitudes according to a tilt value, or according to a pre-emphasis factor, wherein calculating comprises controlling the tilt value or controlling the pre-emphasis factor based on a harmonicity measure of the audio signal, to thereby obtain the set of scale parameters;
generating an encoded audio signal comprising information on an encoded representation of the spectral representation, or the at least part thereof, and information on the encoded representation of the scale parameters or of the modified version of the scale parameters,
wherein the instructions are executed by the processor.
